(19) United States
(12) Patent Application Publication
(10) Pub. No.: US 2019/0050570 A1
(43) Pub. Date: Feb. 14, 2019

(54) COMPUTER RESOURCE ACCESS CONTROL BASED ON THE STATE OF A NON-ACCESSING COMPONENT

(71) Applicant: QUALCOMM Incorporated, San Diego, CA (US)

(72) Inventors: Saravana Krishnan KANNAN, San Diego, CA (US); Kevin GOTZE, Hillsboro, OR (US)

(21) Appl. No.: 15/881,635

(22) Filed: Jan. 26, 2018

Related U.S. Application Data
(60) Provisional application No. 62/545,407, filed on Aug. 14, 2017.

(51) Int. Cl. G06F 21/57; G06F 21/74; G06F 21/75

(52) U.S. Cl. CPC G06F 21/57; G06F 2221/034; G06F 21/755; G06F 21/74

(57) ABSTRACT

A processor is configured to assess the state of a first component of a computing system, and then control whether a second component can access a third component based on the state of the first component to, e.g., mitigate malicious attacks that would exploit changes to the third component. In one example, the computing system includes multiple central processing units (CPUs), at least one of which is equipped to operate in a secure mode for executing secure code that may access sensitive information such as cryptographic keys. In the example, non-secure code is blocked and/or delayed from accessing clock or voltage control registers when any of the CPUs of the system is running secure code. This prevents non-secure code from causing transient faults when secure code is running In some examples, the registers are locked using a global secure-side lock. The lockable registers are referred to herein as grey-list registers.

### CROSS-REFERENCE TO RELATED APPLICATIONS

This application claims priority based on U.S. Provisional Patent Application Ser. No. 62/545,407, filed Aug. 14, 2017, for “Computer Resource Access Control based on the state of a Non-Accessing Component,” which is assigned to the assignee hereof and incorporated by reference herein in its entirety.

### BACKGROUND

### Field of the Disclosure

Various features relate generally to computing systems and more particularly to the preventing unauthorized access to secure or sensitive resources or content.

### Description of Related Art

State-of-the-art computing systems often include multiple central processing units (CPUs). Within such systems, there is often a need to protect the CPUs from malicious attacks that seek to obtain secure information by injecting transient faults or glitches. In one such attack, malicious code running in a non-secure mode on one of the CPUs accesses shared control registers and changes the clock rate and/or voltage of a CPU running in a secure mode to briefly overclock or undervoltage the CPU to inject a fault or glitch that might then expose secure information. Such attacks may apply the overclocking or undervolting only during execution of a specific portion of the secure code, and hence do not necessarily affect other portions of the secure code that need to run for the attack to be successful. If properly timed and applied, such attacks can cause secure code on the system to make erroneous decisions during operation, which might reveal a cryptographic key and thus enable unauthorized transactions such as withdrawal of money from an account.

Other issues may arise in computing systems as well. For example, an attacker may try to glitch (e.g. induce a transient fault) within storage hardware that supports secure and non-secure storage to cause the device to write the secure data into a non-secure area. In that case, it does not matter whether a CPU is running secure code or not. It is the storage hardware which processes the secure storage requests that is vulnerable. Hence, attacks can be directed to cache/memory rather than CPUs. Likewise, the code of concern need not be the non-secure code itself. In one example, non-secure code may ask a direct memory access (DMA) engine (i.e. a non-secure entity) to write to control registers in a manner that might glitch the system. In still other examples, a video decode engine might be glitched to cause the decode engine to transfer protected video content to an unprotected buffer rather than a protected buffer, allowing unauthorized access to the protected content.

It would be desirable to provide techniques to address these and other issues and to thus mitigate at least some malicious attacks.

### SUMMARY

In one aspect, a method for use by a computing system includes: assessing a state of a first component of the computing system; and controlling whether a second component of the computing system can access a third component of the computing system based on the state of the first component.

In another aspect, a device for use with a computing system includes: first, second and third components of the computing system; and a processor configured to assess a state of the first component of the computing system, and control whether the second component can access the third component based on the state of the first component.

In still another aspect, an apparatus for use with a computing system includes: means for assessing a state of a first component of the computing system; and means for controlling whether a second component of the computing system can access a third component of the computing system based on the state of the first component.

### BRIEF DESCRIPTION OF THE DRAWINGS

FIG. 1 is a high-level schematic block diagram of a computing system having multiple central processing units (CPUs), which is equipped with lockable control registers (herein “grey-list registers”) to prevent a non-secure entity from affecting the physical operations of one of the CPUs that is operating in a secure mode.

FIG. 2 is a high-level schematic block diagram of the computing system of FIG. 1 illustrating selected components of one of the CPUs for preventing non-secure code from affecting the physical operations of the CPU while it is in a secure mode.

FIG. 3 is a flow diagram summarizing exemplary procedures for preventing non-secure code from affecting the physical operations of the CPU while it is in a secure mode.

FIG. 4 is a timing diagram summarizing exemplary procedures for preventing non-secure code from affecting the physical operations of the CPU while in secure mode.

FIG. 5 illustrates an exemplary system-on-a-chip (SoC) of a mobile device (UE) wherein the SoC includes components for preventing non-secure code from affecting the physical operations of one of its CPU cores while that CPU core is in a secure mode.

FIG. 6 is a block diagram illustrating an example of a hardware implementation for an apparatus employing a processing system that may exploit the systems, methods and apparatus of FIGS. 1-5 or FIGS. 7-18.

FIG. 7 is a block diagram illustrating exemplary components of a computing and/or processing system equipped with components configured to prevent a non-secure entity from affecting the physical operations a CPU while the CPU is in a secure mode.

FIG. 8 is a flow diagram summarizing exemplary procedures for use by a computing system.

FIG. 9 is a flow diagram also summarizing exemplary procedures for use by a computing system.

FIG. 10 is a block diagram illustrating exemplary components of a generalized computing and/or processing system having multiple components.

FIG. 11 is a block diagram illustrating exemplary components of a computing and/or processing system equipped with a storage controller and voltage and clock sources that affect the physical operations of the storage controller.

FIG. 12 is a block diagram illustrating exemplary components of a first exemplary system equipped with a storage controller and a grey-list controller configured to prevent non-secure code from affecting the physical operations of the storage controller while the storage controller is processing secure content.

FIG. 13 is a flow diagram summarizing exemplary procedures for use by a storage controller to prevent a non-secure entity from affecting the physical operations of the storage controller while the storage controller is processing secure content.

FIG. 14 is a block diagram illustrating exemplary components of a second exemplary system equipped with a storage controller and a grey-list controller configured to prevent non-secure code from affecting the physical operations of the storage controller while the storage controller is processing secure content.

FIG. 15 is a flow diagram summarizing exemplary procedures for use by a secure-mode CPU to prevent a non-secure entity from affecting the physical operations of a storage controller while the storage controller is processing secure content.

FIG. 16 is a block diagram illustrating exemplary components of a computing and/or processing system equipped with a video decoder and voltage and clock sources that affect the physical operations of the video decoder.

FIG. 17 is a block diagram illustrating exemplary components of an exemplary system equipped with a video decoder and a grey-list controller configured to prevent non-secure code from affecting the physical operations of the video decoder while the video decoder is processing protected video content.

FIG. 18 is a flow diagram summarizing exemplary procedures for use by a video decoder to prevent a non-secure entity from affecting the physical operations of the video decoder while the video decoder is processing protected video content.

### DETAILED DESCRIPTION

In the following description, specific details are given to provide a thorough understanding of the various aspects of the disclosure. However, it will be understood by one of ordinary skill in the art that the aspects may be practiced without these specific details. For example, circuits may be shown in block diagrams in order to avoid obscuring the aspects in unnecessary detail. In other instances, well-known circuits, structures and techniques may not be shown in detail in order not to obscure the aspects of the disclosure.

The word “exemplary” is used herein to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation.

### Overview

Several features pertain to methods and apparatus for use with the computing systems that include multiple processors, at least some of which are equipped to operate in a secure mode for executing secure code that may access sensitive information such as cryptographic keys or the like. Other features are directed to addressing other issues in a more generalized manner

As noted above, problems can arise in such systems as a result of malicious attacks that seek to obtain sensitive or secure information by injecting faults or glitches into the system during operation of secure code. In one fault injection attack scenario, malicious code running in a non-secure mode on one of the central processing units (CPUs) accesses shared control registers (or other control resources) and changes the clock rate and/or voltage of a CPU running in a secure mode for a brief period of time to overclock or undervoltage the CPU (to therefor change the clock rate for a given device voltage) to inject a fault to reveal sensitive or secure information. For example, briefly overclocking the CPU may inject or induce a transient operational processing fault that can be used to break the security of the processor to, for example, obtain a security key or enable an otherwise unauthorized transaction. Such attacks can be successful if the attacks are capable of applying the overclocking or undervolting while a specific portion of the secure code is executing (since the malicious attack does not affect the rest of the secure code that still needs to run for the attack to be successful). If properly timed and applied, such attacks can cause secure code on the system to make erroneous decisions during operation, which might reveal a security key and thus enable unauthorized transactions such as withdrawal of money from an account. One goal of the solutions present herein is to prevent non-secure code (or other non-secure entity) from overclocking or undervolting a CPU while the CPU is running secure code, without interfering with the role of non-secure code in transitioning CPU cores between various approved voltage/frequency points, and to do so with minimal design and efficiency costs.

One possible solution is to move all CPU clock and voltage control code to a secure mode. However, this might require: (a) porting all the code to the secure mode operating system/application programming interfaces (APIs); (b) increasing the image size of the secure code (thus adversely consuming more on-chip memory); and (c) switching into a full secure mode for every CPU frequency switch (or for any other control register change that might affect the physical operation of the CPU to overclock or undervoltage the chip). Such changes may have too great an adverse impact on processing design and efficacy, particularly within processing systems for use within portable devices such as smartphones or other wireless communications devices.

Another possible solution is to force all of the CPUs that can run a non-secure CPU clock and/or voltage control driver into a secure mode when any CPU needs to run secure code. However, this may (a) cause a severe performance impact for non-secure code when CPUs need to run secure code and may require (b) code changes to secure code to force all CPUs to secure mode and then back to a non-secure mode. Again, such changes may have too great an adverse impact on processing design and efficacy, particularly within smartphones and other portable devices.

The solutions set forth herein avoid many or all of these issues. Briefly, in one example, all non-secure code is blocked and/or delayed from accessing clock or voltage control registers when any one of the CPUs is running secure code. This serves to prevent non-secure code from causing transient faults when secure code is running More generally, the system detects when any one of the CPUs of the computing system is entering into a secure mode, and then controls access by non-secure code to one or more control resources that affect the physical operation of the CPU to prevent the non-secure code from affecting the physical operation of the CPU. In an example where access to control registers is controlled, the control registers may be any register that stores values that affect the physical operation of the CPU, and hence might be exploited by an attacker to inject faults or glitches to trigger timing errors that might expose secure information. Examples include control registers affecting one or more of clock frequency, clock timing, and processor voltage. By blocking and/or delaying access to the control registers while the CPU is running secure code, any non-secure code programs (such as clock and voltage drivers) running on any of the other CPUs of the system are thereby prevented from modifying the values in the control registers to inject faults into the secure CPU.

Notably, by blocking and/or delaying access to the aforementioned control registers while any one of the CPUs is running secure code, the system need not determine whether a non-secure program is attempting to access those registers or whether any particular changes the non-secure program seeks to make to the register values might be malicious or otherwise damaging. That is, no complicated or predictive detection logic is needed. Modifications to otherwise conventional systems are thus modest. Yet, by blocking and/or delaying access by non-secure code (or other non-secure entities) to the control registers while secure code is running on any one of the CPUs, the system provides the benefit of enhanced security without significant performance impacts (e.g. without the need to switch to a full secure mode to access the protected resource) and without imposing significant increases in secure code image size and/or complexity. In some examples, the access is delayed by a random or pseudorandom amount of time to make it difficult for an attacker to target the exact moment the pertinent code is running The delay may be generated using, for example, a pseudo-random number generator. This random delay is different from the “delay loop” discussed below. It should be understood that any such random or pseudorandom delays are not necessarily imposed only before the control registers are locked or only while the registers are locked. This is discussed further below.

More generally, the access control methods set forth herein may be regarded as providing access control based on a “third party signal,” i.e. access to control resources by one program is controlled by control signals (or signal states) provided by another program (i.e. a “third party”). This is in contrast to access control schemes that control the access to a resource based on the permissions and the state of the accessor. In the access control systems described herein, access is not limited merely by the state of the accessor. It can be limited or controlled by the state of other components (e.g. a third party). Hence, it is the state of another “non-accessor” program (e.g. the secure code running on another one of the CPUs) that may be used to control access.

By way of example, a general method may be provided for use by a computing system that involves assessing a state of a first component of the computing system, and then controlling whether a second component of the computing system can access a third component of the computing system based on the state of the first component even when the second and third components have not changed modes related to security. Assessing the state of the first component of the computing system may include receiving a signal from the first component representative of a security mode of the first component. In some examples, the first component is a secure entity (such as secure code), the second component is a non-secure entity (such as non-secure code), and the third component is a control resource (such as a control register). In the particular example discussed above, the first component is a CPU of a multiple CPU system where the CPU is entering a secure mode, the second component is non-secure code running on another one of the CPUs, and the third component includes one or more control registers or resources that affect physical operations of the CPU entering the secure mode. As noted, access to the control registers may be blocked and/or delayed. The first component is the “third party.”

Notably, however, techniques described herein are not limited to addressing issues where the physical operations of a CPU are controlled by the control registers. And the techniques are not limited to preventing physical attacks on a CPU. As noted above, an attacker may try to induce a fault within storage hardware that supports secure and non-secure storage to cause the device to write the secure data into a non-secure area. In that case, it does not matter whether a CPU is running secure code or not. Techniques described herein may be applied to protecting against attacks directed to cache/memory rather than CPUs. Likewise, techniques described herein may be applied to protecting against attacks where code of concern need not be the non-secure code itself but a direct memory access (DMA) engine (i.e. a non-secure entity).Particular examples are described herein were access to control registers are locked but this is just one example of a more general technique. The techniques herein are not limited to controlling access to control registers but may be more generally applied to controlling access to content, including memory contents. By way of example, techniques are described herein for use with a video decode engine to protect against unauthorized access to protected video content by a malicious entity.

Herein, within examples where access to control registers is blocked and/or delayed during execution of secure code on any of the CPUs are called “grey-listed” or “grey-list” registers, although other names could be used instead. Examples of such registers include registers affecting one or more of clock frequency, clock timing, and voltage. In some examples, access to the grey-listed registers is blocked by locking the grey-listed registers prior to any one of the CPUs entering into a secure mode to run secure code. In examples where the secure mode is a trusted execution environment, such as TrustZone® (TZ), access to the grey-listed registers may be locked by invoking a global secure-side lock on the grey-listed registers (where, herein, a global secure-side lock generally refers to locking grey list registers in a generic sense, rather than referring to any implementation-specific use of the term global secure-side lock). By global, it is meant that the same lock is used across all CPUs. By secure-side, it is meant that the lock is only modifiable by secure code. Once locked, access to the grey-listed registers by non-secure code may be limited by a secure interface such as a secure input/output (IO) application programming interface (API) or other secure access scheme or mechanism. (Some of the features of an exemplary secure IO API are discussed in more detail below).

Notably, the functions of the secure IO API may be implemented using a variety of different systems and, in particular, may be instead implemented in hardware. For example, all the locking and unlocking may be implemented in hardware so that from the non-secure side, grey-list register (GLR) read/writes just look like normal register read/writes, except the read/writes might take longer to finish (because they are delayed in hardware when another CPU is in secure mode). Also, note that the locking of the grey-list registers is not limited to access from non-secure code. If a non-secure code asks a DMA engine to write to the grey-list registers, the DMA engine can be blocked. That is, the grey-list registers may be locked to all components except a secure entity (e.g. a CPU operating in secure mode or another digital signal processor (DSP) operating in secure mode, etc.).

To prevent an attacker from triggering a delayed attack by changing a grey-listed register prior to a CPU entering the secure mode in a manner that would result in delayed overclocking or undervolting, the system may, upon locking the grey-listed registers, activate a delay processing loop within the secure mode CPU to delay execution of any secure code on the CPU. The delay processing loop may be set to a duration sufficiently long (e.g. a few milliseconds) so any malicious change made by non-secure code to the grey-listed registers prior to the grey-listed lock would cause the secure mode CPU to fail prior to execution of pertinent portions of secure code (or, generally speaking, prior to execution of at least some of the secure code). In this regard, the delay processing loop may run in a secure mode context and hence the delay loop may be secure code too. The secure code delay loop may be configured to cause the CPU to fail before a predetermined sensitive/important/vulnerable portion of the remaining secure code is executed (i.e. before execution of the aforementioned “pertinent portions” of the secure code). In this manner, malicious overclocking or undervolting will cause the CPU to malfunction and reset before it runs the sensitive/important/vulnerable portions of the secure code, and so the attack would not expose any sensitive information. This delay loop is different from the random or pseudorandom delays noted above.

To prevent an attacker from launching an attack that, prior to a CPU entering the secure mode, sets the CPU voltage to a low threshold level sufficient to run non-secure code but which would inject faults into secure code, the system may, upon locking the grey-listed registers, activate a power processing loop within the secure mode CPU. The power processing loop stresses the CPU so that the low threshold voltage would cause the CPU to fail prior to running pertinent portions of secure code, i.e. the predetermined sensitive/important/vulnerable part of the secure code. As with the delay processing loop, the power processing loop may be secure code set to a duration sufficiently long so that the low voltage set by the attacker causes the secure mode CPU to fail prior to execution of the pertinent portions of secure code are executed. Hence, the low voltage attack will cause the CPU to malfunction and reset before it runs sensitive/important/vulnerable secure code, and so the attack again would not expose any sensitive information.

As noted, accesses to control registers may be delayed by random or pseudorandom amounts of time to make it difficult for an attacker to target the exact moment pertinent code is running and hence help mitigate attacks such as CLKSCREW attacks. These random delays are different from the “delay loop” discussed above. Such random or pseudorandom delays are not necessarily imposed only before the control registers are locked or only while the registers are locked. By way of example, a random delay may be inserted into (or imposed on) each attempted access of the grey-list register by non-secure code before, during, or while the grey-list registers are locked and those delays may be of an arbitrary duration (e.g. relatively short or relatively long). In some examples, these delays might not be imposed until a secure side component finishes. These delays are not necessarily imposed by a secure component that triggers locking of the grey-list registers but might be imposed by another secure component. The actual delay may be imposed by secure IO in implementations that use secure IO. And so accesses to control registers might be delayed by a random amount (instead of just waiting until the control register is unlocked or until the secure component finishes is secure operations).

These and other features are discussed in greater detail below.

One possible and general advantage of at least some of the systems and procedures described herein is that clock control, voltage control and other hardware control processing need not be configured within secure mode code to prevent the malicious attacks. Rather, clock and voltage control can remain within non-secure code while still preventing attacks by grey-listing the control registers. If, instead, the clock and voltage control were moved to secure mode code to prevent the attacks, one possible disadvantage might be that such could require an increase in the complexity of the secure code, thus increasing the chances of more bugs and vulnerabilities in secure code. (It is generally a good design principle to keep secure mode code as simple and limited as possible.) Another disadvantage might be that the increase in secure code could also require an increase in memory requirements of secure mode code which entails additional area cost on a chip (since secure memory is special memory inside the chip and hence generally more expensive than additional non-secure memory). A further disadvantage could be reduced performance because non-secure code might need to keep switching to secure-mode just to perform non-malicious functions that might need to be performed often or which needs to be done with low latency.

### Control Register Locking Examples

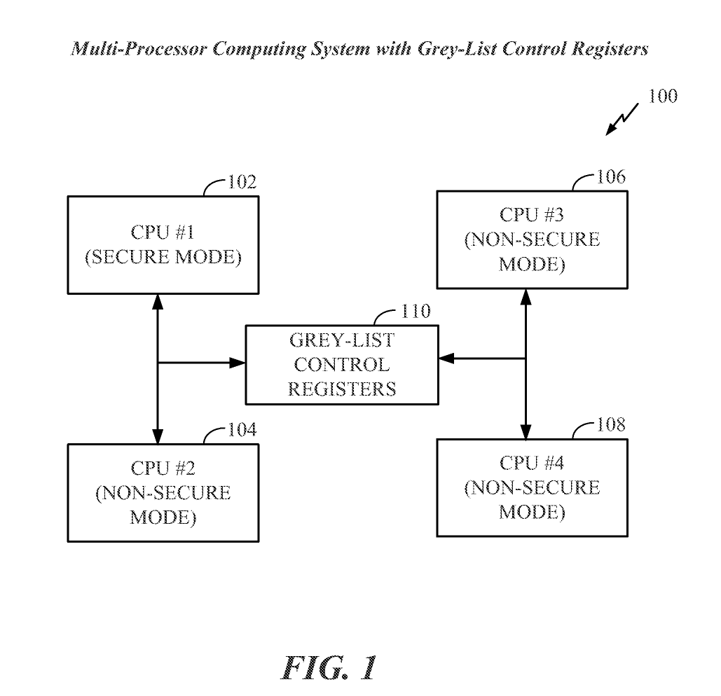

FIG. 1 is a high-level block diagram illustrating a multiple CPU computing system 100 having four CPUs—CPU #1 (102), CPU #2 (104), CPU #3 (106), CPU #4 (108)—connected or coupled to a set of grey-list control registers 110, i.e. one or more control registers that affect the physical operation of the various CPUs, such as clock and voltage registers. In general, any of the CPUs can operate in a secure mode or a non-secure mode. In the particular example of FIG. 1, only CPU #1 is in the secure mode.

To prevent non-secure code running on one of the other three CPUs from launching an attack against the secure mode CPU (i.e. CPU #1) by changing the clock frequency and/or voltage of CPU #1 to inject faults, the CPU #1 (102) locks the grey-list control registers 110 prior to entering its secure mode. As discussed above, this enhances security by helping to prevent an attacker from exposing secure information within the secure code of CPU #1. And, as discussed, the CPU #1 (102) may invoke additional protections such as by running time delay processing loops or power processing loops, etc. Upon exiting from the secure mode, the CPU #1 (102) unlocks the grey-list control registers 110. If so equipped, one of the other CPUs may eventually enter a secure mode and lock the same grey-list control registers 110 while it is in the secure mode.

In this manner, any CPU running any secure code within the computing system 100 locks the grey-list control registers 110 while it is in secure mode so that any non-secure code running anywhere on the computing system 100 is prevented from tampering with the clock frequency or voltage (or other physical control parameters) to launch attacks. In many multiple CPU systems, each of the CPUs runs at the same clock rate and voltage as the other CPUs since all are formed on a single processing chip. An example of a System-on-a-Chip (SoC) having multiple CPUs is discussed below. When each CPU shares the same clock and voltage, only a small number of grey-list registers are employed, and a change in clock frequency or voltage using those registers affects all CPUs of the system. In other examples, however, each CPU may have a different clock rate and perhaps a different voltage as well. In such examples, multiple grey-list registers are provided, with separate registers corresponding to the different CPUs. In such a system, only the grey-listed registers associated with a particular CPU operating in a secure mode is locked while secure code is running on that CPU. Other control registers that control the clock frequency and/or voltage for the other CPUs need not be locked.

Herein, examples are described where clock and voltage registers are locked. However, access to any control resource that affects the physical operation of a CPU or a portion thereof may be controlled in some examples. These resources may be described as “physical hardware control resources” and the parameters maintained therein may be referred to as “physical hardware operating parameters” or just hardware operating parameters. The physical hardware control resources are distinct from functional software control resources that instead control the software of a CPU. Clock frequency, clock rate, and voltage control resources are just some examples of physical hardware control resources. Other examples include resources that control the selective gating of clock signals or that control the timing of the leading or trailing edges of clock signals. Still other examples include resources that explicitly control the temperature of the CPU or other physical or environmental parameters.

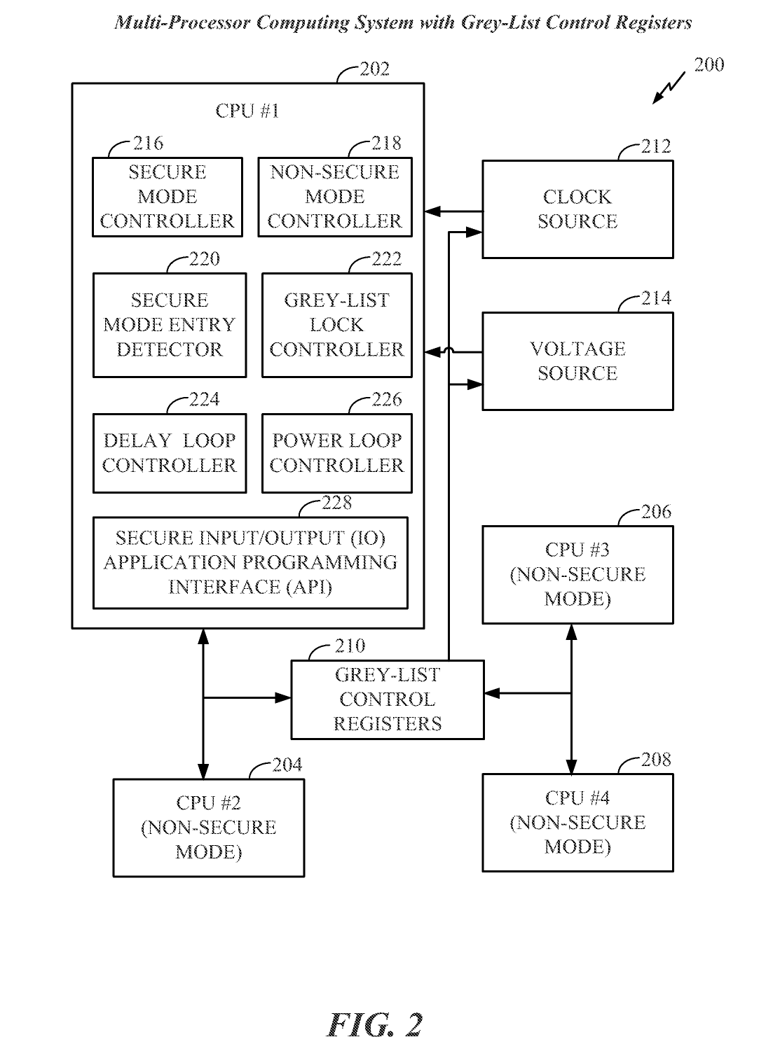

FIG. 2 is a high level block diagram of a multiple CPU system 200 illustrating selected components relevant to grey-list control. In this example, selected components of CPU #1 202 are shown, but it should be understood that each of the other CPUs (204, 206 and 208) may be provided with the same or similar components for controlling the grey-list register 210. Also, a clock source 212 and a voltage source 214 are shown connected or coupled to CPU #1. The clock and voltage sources are also connected or coupled to the other CPUs, which is not explicitly shown to enhance the clarity of the overall drawing.

Briefly, CPU #1 (202) includes a secure mode controller 216 and a non-secure mode controller 218. The secure mode controller 216 controls secure mode operations of the CPU such as kernel mode operations and, in some examples, may be a TZ controller. The non-secure mode controller 218 controls non-secure mode operations of the CPU such as user space operations. A secure mode entry detector 220 detects when the CPU is entering into (or is otherwise invoking or initiating) secure mode operations. This may be achieved by, for example, detecting the triggering or activation of secure code within CPU #1 or by monitoring various internal flags or control parameters that indicate the mode of operation of the CPU (or portions thereof). A grey-list lock controller 222 is equipped to lock the grey-list registers 210 prior to entry of the CPUS #1 into the secure mode (i.e. prior to execution of any secure code) and to unlock when the CPU exits the secure mode.

A delay loop controller 224 may be provided to initiate a delay loop to delay the execution of pertinent portions of secure code by an amount sufficient so any malicious change made by non-secure code to the grey-listed registers 210 prior to the global lock would cause the CPU #1 (202) to fail prior to execution of pertinent portions of secure code within the secure mode. Hence, any malicious overclocking or undervolting of the CPU #1 triggered by non-secure code will cause CPU #1 to fail and reset before pertinent portions of secure code are run and any sensitive information is exposed by any transient faults triggered by the overclocking or undervolting.

A power loop controller 226 may be provided to initiate a power processing loop that consumes sufficient power (or otherwise stresses the CPU #1) so that a low threshold voltage (i.e. a voltage sufficient to run non-secure code but which would inject faults into secure code) set prior to the global lock would cause the CPU to fail prior to running pertinent portions of secure code. As with the aforementioned delay processing loop, the power processing loop may be set to a duration sufficiently long so that any low voltage set by the attacker causes the secure mode CPU to fail prior to execution of pertinent portions of secure code. Hence, the low voltage attack will cause the CPU to malfunction and reset before it runs pertinent portions of secure code, and so the attack would not expose any sensitive information.

A secure IO API 228 or similar suitable secure software or hardware interface may be provided to control access to the grey-list registers 210. That is, direct access to the grey-list registers by non-secure code may be blocked and/or delaying using any suitable hardware or software schemes. If a secure IO API is used, it can handle the locking/unlocking based on the aforementioned third party signal. Secure IO API is used in some particular implementations if there is not enough hardware resources/capability to block one register at a time. For example, blocking accesses from non-secure code is sometimes only possible with 4 KB granularity (meaning all registers in a particular 4 KB region are either blocked or unblocked). Also, in examples where access is delayed when grey-list registers are locked, the delay can be readily implemented using a secure IO API software. Hardware schemes for locking generally just reject access, rather than delay the access. Notably, a secure IO API or other software mechanisms are not required. Hardware control mechanisms may be used to reject access to grey-list registers. Control can be turned on/off based on whether or not any CPU is executing secure-code. However, when secure IO API is used to implement the GLC, the secure IO API itself may run in one of the several secure modes in the CPU. In such implementations, the locking of the control registers does not occur prior to the CPU entering the secure mode but occurs after the CPU enters a secure mode (and invokes secure IO) but before the CPU executes sensitive code (i.e. pertinent code that is predetermined to be particularly sensitive, important or vulnerable. Hence, generally speaking, one or more control registers may be locked (a) prior to at least one CPU entering the secure mode or (b) after the at least one CPU enters the secure mode but before the at least one CPU executes the sensitive code.

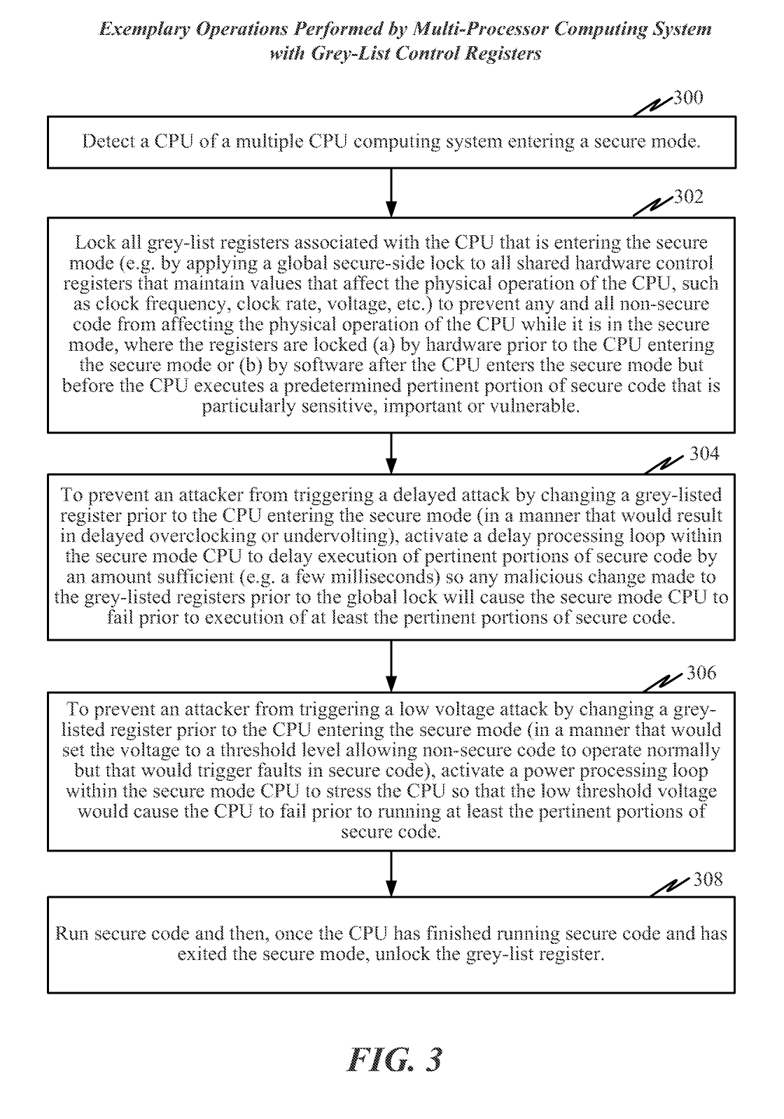

FIG. 3 is a flow diagram summarizing some of these features. Briefly, at 300, the system detects a CPU of a multiple CPU computing system entering a secure mode. At 302, all grey-list registers associated with the CPU that is entering the secure mode are locked by the system (by, e.g., applying a global secure-side lock to all shared hardware control registers that maintain values that affect the physical operation of the CPU, such as clock frequency, clock rate, voltage, etc., to block and/or delay access to those registers, where the delay may be imposed by a random or pseudorandom amount of time in the manner discussed above) to prevent any and all non-secure code from affecting the physical operation of the CPU while it is in the secure mode, where the registers are locked (a) by hardware prior to the CPU entering the secure mode or (b) by software after the CPU enters the secure mode but before the CPU executes a predetermined pertinent portion of code that is particularly sensitive, important or vulnerable. At 304, to prevent an attacker from triggering a delayed attack by changing a grey-listed register prior to the CPU entering the secure mode (in a manner that would result in delayed overclocking or undervolting), the system activates a delay processing loop within the secure mode CPU to delay execution of at least the pertinent portions of secure code by an amount sufficient (e.g. a few milliseconds) so any malicious change made to the grey-listed registers prior to the global lock will cause the secure mode CPU to fail prior to execution of the pertinent portions of secure code (i.e. the most sensitive portions). At 306, to prevent an attacker from triggering a low voltage attack by changing a grey-listed register prior to the CPU entering the secure mode (in a manner that would set the voltage to a threshold level allowing non-secure code to operate normally but that would trigger faults in secure code), the system activates a power processing loop within the secure mode CPU to stress the CPU so that the low threshold voltage would cause the CPU to fail prior to running at least the pertinent portions of secure code. At 308, secure code is run by the secure-mode CPU and then, once the CPU has finished running the secure code and has exited the secure mode, the grey-list register is unlocked by the system.

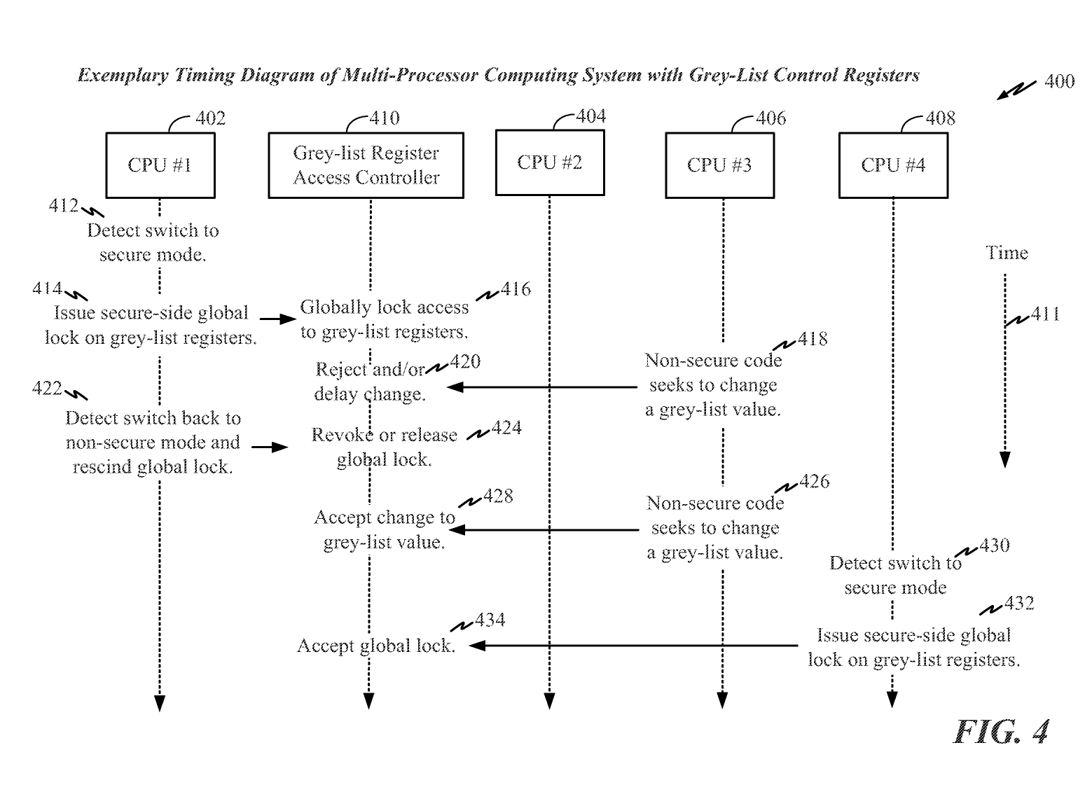

FIG. 4 is timing diagram 400 that further summarizes some of these features. In the diagram of FIG. 4, the operations of four CPUs are shown—CPU #1 (402), CPU #2 (404), CPU #3 (406), CPU #4 (408)—along with the operations of a grey-list register access controller 410. In some examples, the functions of the grey-list register access controller 410 are performed by the secure IO API. In other examples, the functions may be implemented in hardware. Time advances along the vertical access as shown by arrow 411. In this particular example, at 412, components within the CPU #1 (402) detect a switch to a secure mode (i.e. one or more secure programs are activated or otherwise invoked to run on CPU #1). At 414, components within the CPU #1 (402) issue a secure-side global lock on the grey-list register access controller 410. At 416, the grey-list register access controller 410 globally locks down access to the grey-list registers.

Later, at 418, non-secure code running on CPU #3 (406) seeks to change one of the grey-list values, perhaps to change the clock rate. The change might be legitimate or it might be a malicious code seeking to trigger a transient fault within CPU #1 (402). In either case, the change is rejected and/or delayed at 420 by the grey-list register access controller 410. Depending upon the particular implementation, the grey-list register access controller 410 may be locked is such a manner that the non-secure code does not even “see” the registers and hence cannot even seek to change the values of the registers. If the change is rejected (because the register is locked), the change request can be repeated later (as discussed below in connection with item 426). If the change request is instead delayed, the change request may be automatically accepted once the grey-list register is no longer locked, so that the requesting code need not repeat the change request. This delay strategy may be a simpler to implement.

Still later, at 422, components within the CPU #1 (402) detect a switch back to a non-secure mode (i.e. the secure programs running on CPU #1 have terminated their operations) and the global lock is rescinded or withdrawn. In response, at 424, the grey-list register access controller 410 revokes the global lock and again allows code to access and modify the values within the register(s). In this particular example, non-secure code running on the CPU #3 (406) again seeks to change a grey-list value, at 426. Now, since the register(s) are unlocked, the grey-list register access controller 410 accepts the change in the grey-list values. Still yet later, at 430, another CPU (e.g. CPU #4) detects a switch to a secure mode (i.e. components within CPU #4 detect that one or more secure programs are activated or otherwise invoked to run on CPU #4). At 432, components within the CPU #4 (408) issue a secure-side global lock on the grey-list register(s) via the grey-list register access controller 410, which accepts the lock at 434.

For brevity, further processing is not shown in FIG. 4 but, eventually, the lock invoked by CPU #4 will be withdrawn. FIG. 4 also does not specifically illustrate some of the other features, such as the aforementioned time delay loops or power loops. Rather, FIG. 4 is intended to merely illustrate and highlight selected processing features.

### Exemplary System-on-a-Chip (SoC) Hardware Environment

Aspects of the systems and methods described herein can be exploited using a wide variety of devices for a wide range of applications. To provide a concrete example, an exemplary SoC hardware environment will now be described wherein grey-list components are provided on a SoC processing circuit that is used in a mobile communication device or other access terminal. The particular example is a Qualcomm Snapdragon® chip, which is provided with hardware (HW) and software (SW) components to establish a trusted execution environment. The trusted execution environment in this example is TrustZone® (TZ) provided by ARM® (where TrustZone and ARM are registered trademarks/service marks of ARM Limited Corporation). However, this example is merely illustrative and the various security techniques described herein are broadly applicable to other computing systems and to systems employing other secure processing environments or trust environments.

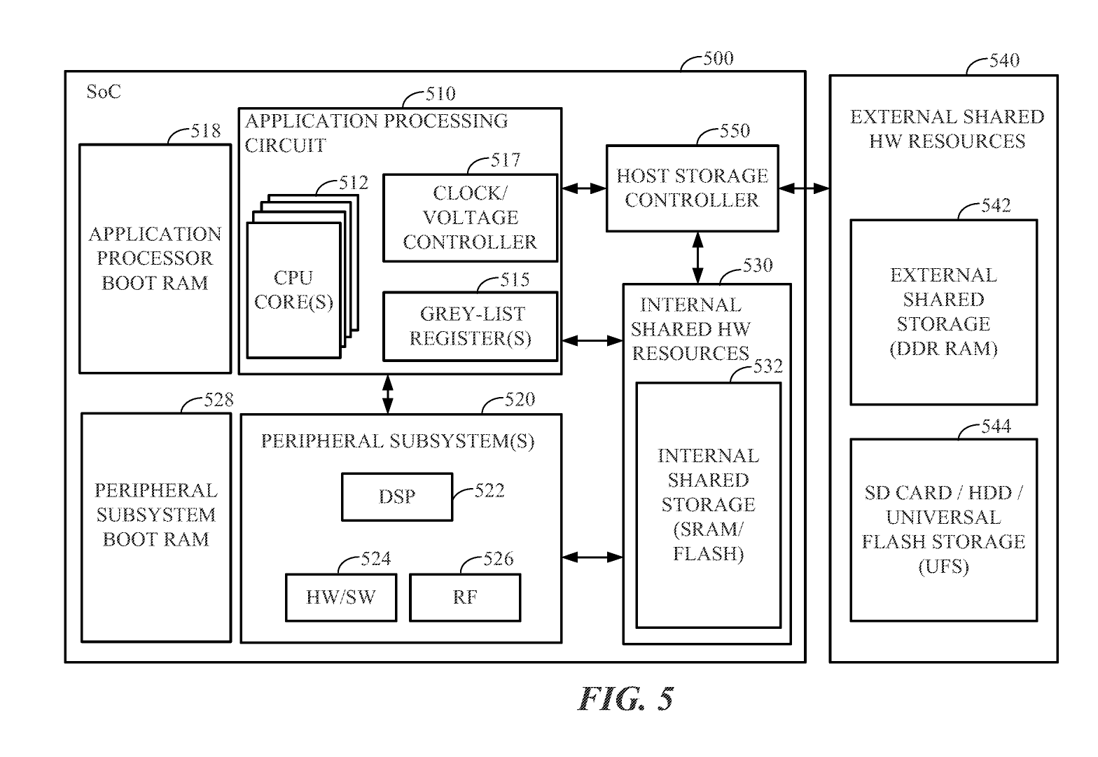

FIG. 5 illustrates a SoC processing circuit 500 of a mobile communication device that includes an application processing circuit 510, which includes a multi-core CPU 512, having multiple individual CPUs. The application processing circuit 510 may control the operation of all components of the mobile communication device. In this example, the application processing circuit 510 is equipped with a set of grey-list registers 515 (and other non-grey-list registers, not shown). A clock/voltage controller 517 is also shown for controlling the clock rate and voltage applied to, at least, the CPU cores 512 (as well as other components of the overall SoC).

Using the techniques described above, programs running on the CPU cores 512 can issue global locks to the grey-list register(s) 515 to prevent, or at least mitigate the risk of, malicious attacks that seek to trigger transient faults or glitches in the operations of the CPU cores while operating in a secure mode. The CPU cores 512 may be Reduced Instruction Set Computing (RISC) processors, such as ARM® RISC processors that are equipped with TrustZone® (TZ) or similar trusted execution environment architectures. Briefly, TZ provides a system-wide approach to security for use on numerous chips to protect services and devices, including smartphones, tablets, personal computers, wearables, etc. TZ is often built into SoCs by semiconductor chip designers who want to provide secure End Points and Roots of Trust. Although described primarily in connection with examples wherein the CPUs are RISC processors and the trusted execution environment is TZ, various features described herein may be exploited within other processor systems or within other trust systems and protocols and, in particular, within computing systems that do not implement TZ.

In the example of FIG. 5, secure code is configured to lock out all frequency, voltage and timing control related registers (which are the aforementioned “grey-listed” registers) from non-secure code. When switching from non-secure context to TZ secure mode context, TZ obtains a global secure-side lock, e.g. a “greylist_lock.” When switching from TZ secure mode context to non-secure context, TZ secure code releases the global secure-side lock (greylist_lock). Secure 10 API (or other suitable components) is configured to obtain (i.e. “grab”) the secure-side greylist_lock (and to wait on the lock if currently held) when accessing grey-listed registers, and to then release the greylist_lock once it is done accessing the grey-listed registers. Note that the lock is a true lock and not a mere flag so as to avoid a possible race condition where a switch to TZ secure code context is triggered right after the secure 10 API checks a global flag. These features and configurations help ensure that the frequency and voltage of the CPU cores cannot be changed while any CPU core is running secure code in TZ, i.e. this prevents any targeted application of malicious overclocking or undervolting to defeat the attack vector.

As discussed above, circumstances may arise where an attacker might set a grey-listed register to cause a delayed overclocking/undervolting and then call into TZ secure code. To address this concern, a delay loop is added on the TZ secure code-side after obtaining the greylist_lock. This helps ensure that any delayed overclocking or undervolting will crash the TZ secure code while it is executing the delay loop before it starts executing sensitive code so the attack is thwarted before sensitive information is exposed. A period of a 4 or 5 milliseconds may be sufficient in some examples, although this depends on processor speed, voltage, etc., and a wider range of 3 to 6 milliseconds may be appropriate in other examples. Otherwise routine experimentation may be employed to determine suitable or optimal durations for the time delay loop.

Circumstances may also arise where an attacker sets the registers in such a way that the voltage is just sufficient to run most of the code (i.e. the voltage is set at or slightly above a minimum non-secure processing threshold), but the voltage is not sufficient to execute the sensitive TZ secure code (i.e. the voltage is set below a minimum secure processing threshold). To address the issue, instead of a simple delay loop after obtaining the greylist_lock, the TZ secure code also executes a so-called “power virus code” to force a crash if the voltage is below the minimum secure processing threshold. In this regard, a power virus is a computer program configured to execute machine code designed to reach maximum CPU power dissipation. Although a power virus can be run to the point that the CPU physically overheats and is damaged, in the present case, the power virus is run only long enough to substantially ensure that any malicious transient fault attack occurring during that time will trigger a fault and hence reset of the system (thus thwarting the attack before secure information might be exposed). Again, a period of a 4 or 5 milliseconds may be sufficient. Otherwise routine experimentation may be employed to determine suitable or optimal durations.

Circumstances may also arise where there is an expectation in hardware that two separate accesses to grey-listed registers must to happen within a time frame. In general, any such requirement cannot be guaranteed even in the absence of security issues and so such hardware should be considered inadequate and in need of redesign. However, if one wants to meet the same timing guarantees as without the grey-list solution for the security issue, then the driver on the non-secure side that makes the call to run TZ secure code (e.g. a secure monitor call (SMC) driver) should obtain a write semaphore at the time of the call into TZ secure code. Any driver (e.g. clock driver, etc.) that has a timing requirement between two accesses to grey-listed registers should obtain a read semaphore across the two grey-listed register access (e.g. through secure IO APIs or other suitable interface components). The use of read/write semaphores thereby should ensure that multiple drivers accessing grey-listed registers do not contend with one another but will only contend with SMC calls (or the like).

Continuing now with the description of the components of exemplary SoC 500, the application processing circuit 510 is coupled to a host storage controller 550 for controlling storage of data in an internal shared storage device 532 that forms part of internal shared hardware (HW) resources 530. The application processing circuit 510 may also include a boot RAM or ROM 518 that stores boot sequence instructions for the various components of the SoC processing circuit 500. The SoC processing circuit 500 further includes one or more peripheral subsystems 520 controlled by application processing circuit 510. The peripheral subsystems 520 may include but are not limited to a storage subsystem (e.g., read-only memory (ROM), random access memory (RAM)), a video/graphics subsystem (e.g., digital signal processing circuit (DSP), graphics processing circuit unit (GPU)), an audio subsystem (e.g., DSP, analog-to-digital converter (ADC), digital-to-analog converter (DAC)), a power management subsystem, security subsystem (e.g., encryption components and digital rights management (DRM) components), an input/output (I/O) subsystem (e.g., keyboard, touchscreen) and wired and wireless connectivity subsystems (e.g., universal serial bus (USB), Global Positioning System (GPS), Wi-Fi, Global System Mobile (GSM), Code Division Multiple Access (CDMA), 4G Long Term Evolution (LTE) modems). The exemplary peripheral subsystem 520, which is a modem subsystem, includes a DSP 522, various other hardware (HW) and software (SW) components 524, and various radio-frequency (RF) components 526. In one aspect, each peripheral subsystem 520 also includes a boot RAM or ROM 528 that stores a primary boot image (not shown) of the associated peripheral subsystems 520. As noted, the SoC processing circuit 500 further includes various internal shared HW resources 530, such as the aforementioned internal shared storage 532 (e.g. static RAM (SRAM), flash memory, etc.), which is shared by the application processing circuit 510 and the various peripheral subsystems 520 to store various runtime data or other parameters and to provide host memory and which may store various keys or passwords for secure processing.

In one aspect, the components 510, 518, 520, 528 and 530 of the SoC 500 are integrated on a single-chip substrate. The SoC processing circuit 500 further includes various external shared HW resources 540, which may be located on a different chip substrate and may communicate with the SoC processing circuit 500 via one or more buses. External shared HW resources 540 may include, for example, an external shared storage 542 (e.g. double-data rate (DDR) dynamic RAM) and/or permanent or semi-permanent data storage 544 (e.g., a secure digital (SD) card, hard disk drive (HDD), an embedded multimedia card, a universal flash device (UFS), etc.), which may be shared by the application processing circuit 510 and the various peripheral subsystems 520 to store various types of data, such as an operating system (OS) information, system files, programs, applications, user data, audio/video files, etc. When the mobile communication device incorporating the SoC processing circuit 500 is activated, the SoC processing circuit begins a system boot up process in which the application processing circuit 510 may access boot RAM or ROM 518 to retrieve boot instructions for the SoC processing circuit 500, including boot sequence instructions for the various peripheral subsystems 520. The peripheral subsystems 520 may also have additional peripheral boot RAM or ROM 528.

### Additional Exemplary Systems and Methods

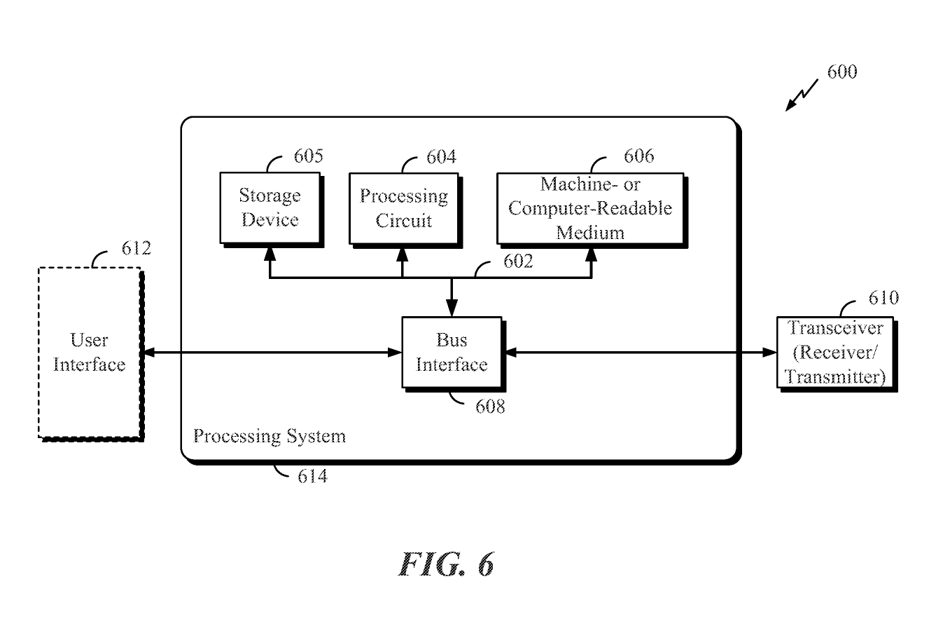

FIG. 6 illustrates an overall system or apparatus 600 in which the systems, methods and apparatus of FIGS. 1-5 may be implemented. In accordance with various aspects of the disclosure, an element, or any portion of an element, or any combination of elements may be implemented with a processing system 614 that includes one or more processing circuits 604, such as the SoC of FIG. 5. Depending upon the device, apparatus 600 may be used with a radio network controller (RNC).

In the example of FIG. 6, the processing system 614 may be implemented with a bus architecture, represented generally by bus 602. The bus 602 may include any number of interconnecting buses and bridges depending on the specific application of the processing system 614 and the overall design constraints. The bus 602 links various circuits including one or more processing circuits (represented generally by the processing circuit 604), the storage device 605, and a machine-readable, processor-readable, processing circuit-readable or computer-readable media (represented generally by a non-transitory machine-readable medium 606) The bus 602 may also link various other circuits such as timing sources, peripherals, voltage regulators, and power management circuits, which are well known in the art, and therefore, will not be described any further. The bus interface 608 provides an interface between bus 602 and a transceiver 610. The transceiver 610 provides a means for communicating with various other apparatus over a transmission medium. Depending upon the nature of the apparatus, a user interface 612 (e.g., keypad, display, speaker, microphone, joystick) may also be provided but is not required.

The processing circuit 604 is responsible for managing the bus 602 and for general processing, including the execution of software stored on the machine-readable medium 606. The software, when executed by processing circuit 604, causes processing system 614 to perform the various functions described herein for any particular apparatus. Machine-readable medium 606 may also be used for storing data that is manipulated by processing circuit 604 when executing software.

One or more processing circuits 604 in the processing system may execute software or software components. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise. A processing circuit may perform the tasks. A code segment may represent a procedure, a function, a subprogram, a program, a routine, a subroutine, a module, a software package, a class, or any combination of instructions, data structures, or program statements. A code segment may be coupled to another code segment or a hardware circuit by passing and/or receiving information, data, arguments, parameters, or memory or storage contents. Information, arguments, parameters, data, etc. may be passed, forwarded, or transmitted via any suitable means including memory sharing, message passing, token passing, network transmission, etc.

The software may reside on machine-readable medium 606. The machine-readable medium 606 may be a non-transitory machine-readable medium or computer-readable medium. A non-transitory processing circuit-readable, machine-readable or computer-readable medium includes, by way of example, a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), RAM, ROM, a programmable ROM (PROM), an erasable PROM (EPROM), an electrically erasable PROM (EEPROM), a register, a removable disk, a hard disk, a CD-ROM and any other suitable medium for storing software and/or instructions that may be accessed and read by a machine or computer. The terms “machine-readable medium”, “computer-readable medium”, “processing circuit-readable medium” and/or “processor-readable medium” may include, but are not limited to, non-transitory media such as portable or fixed storage devices, optical storage devices, and various other media capable of storing, containing or carrying instruction(s) and/or data. Thus, the various methods described herein may be fully or partially implemented by instructions and/or data that may be stored in a “machine-readable medium,” “computer-readable medium,” “processing circuit-readable medium” and/or “processor-readable medium” and executed by one or more processing circuits, machines and/or devices. The machine-readable medium may also include, by way of example, a carrier wave, a transmission line, and any other suitable medium for transmitting software and/or instructions that may be accessed and read by a computer.

The machine-readable medium 606 may reside in the processing system 614, external to the processing system 614, or distributed across multiple entities including the processing system 614. The machine-readable medium 606 may be embodied in a computer program product. By way of example, a computer program product may include a machine-readable medium in packaging materials. Those skilled in the art will recognize how best to implement the described functionality presented throughout this disclosure depending on the particular application and the overall design constraints imposed on the overall system.

One or more of the components, steps, features, and/or functions illustrated in the figures may be rearranged and/or combined into a single component, block, feature or function or embodied in several components, steps, or functions. Additional elements, components, steps, and/or functions may also be added without departing from the disclosure. The apparatus, devices, and/or components illustrated in the Figures may be configured to perform one or more of the methods, features, or steps described in the Figures. The algorithms described herein may also be efficiently implemented in software and/or embedded in hardware.

The various illustrative logical blocks, modules, circuits, elements, and/or components described in connection with the examples disclosed herein may be implemented or performed with a general purpose processing circuit, a DSP, an application specific integrated circuit (ASIC), a field programmable gate array (FPGA) or other programmable logic component, discrete gate or transistor logic, discrete hardware components, or any combination thereof designed to perform the functions described herein. A general purpose processing circuit may be a microprocessing circuit, but in the alternative, the processing circuit may be any conventional processing circuit, controller, microcontroller, or state machine. A processing circuit may also be implemented as a combination of computing components, e.g., a combination of a DSP and a microprocessing circuit, a number of microprocessing circuits, one or more microprocessing circuits in conjunction with a DSP core, or any other such configuration.

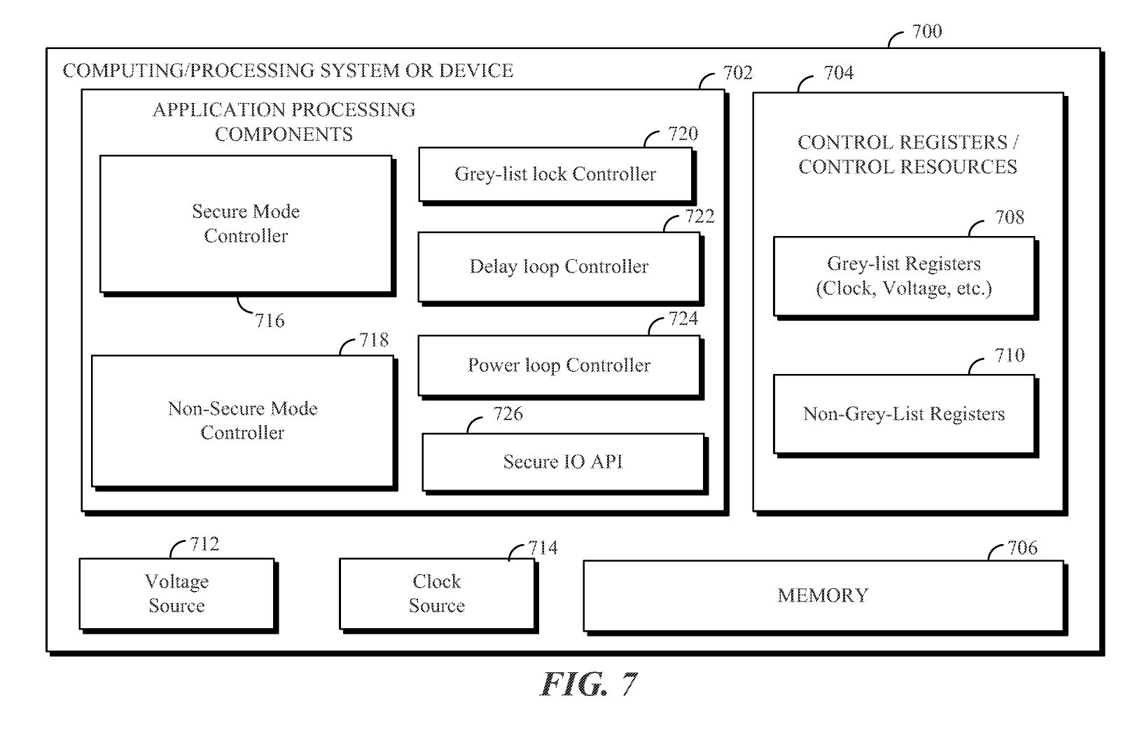

Hence, in one aspect of the disclosure, processing circuit 604 illustrated in FIG. 6—or components thereof—may be a specialized processing circuit (e.g., an ASIC)) that is specifically designed and/or hard-wired to perform the algorithms, methods, and/or blocks described in FIGS. 1, 2, 3, 4, and 5 (and those illustrated in FIGS. 7, 8, 9, 10, 11, 12, 13, 14, 15, 16, 17 and 18 discussed below). Thus, such a specialized processing circuit (e.g., ASIC) may be one example of a means for executing the algorithms, methods, and/or blocks described in FIGS. 1, 2, 3, 4, and 5 (and those illustrated in FIGS. 7, 8, 9, 10, 11, 12, 13, 14, 15, 16, 17 and 18, discussed below). The machine-readable storage medium may store instructions that when executed by a specialized processing circuit (e.g., ASIC) cause the specialized processing circuit to perform the algorithms, methods, and/or blocks described herein.

FIG. 7 illustrates selected and exemplary components of a computing or processing system or device 700 having application processing components 702 that operate in conjunction with a set of control registers (or other control resource) 704 and a system memory 706. The control registers 704 include grey-list registers 708 that can be locked using the techniques discussed above and which maintain values that affect the physical operations of CPU cores of the computing system (not separately shown in FIG. 7). The control registers 704 also include non-grey-list registers 710 that do not maintain values affecting the physical operations of CPU cores and hence are not locked using the techniques described herein. A voltage source 712 and a clock source 714 are shown, which provide clock and voltage to the various other components, respectively.

The application processing components 702 include a Secure Mode Controller 716, which may be a TZ controller, and which controls secure mode operations. A Non-Secure Mode Controller 718, which may be a user mode controller, controls non-secure mode operations. A Grey-list lock Controller 720 operates to lock and unlock the grey-list registers 708, using techniques already described. A Delay Loop Controller 722 and a Power Loop Controller 724 may optionally invoke delay loops and power virus loops, as already discussed.

The various components of FIG. 7 may be replaced with a suitable means for performing or controlling corresponding operations. Hence, in at least some examples, means are provided for detecting a CPU of a computing system entering a secure mode, wherein the computing system has a plurality of CPUs, and means are provided for controlling access by non-secure code to one or more control resources that affect the physical operation of the CPU to prevent the non-secure code from affecting the physical operation of the CPU that is entering the secure mode. A system may thus comprise one or more of such means.

In some examples, the means for controlling access by the non-secure code to the one or more control resources or registers includes means for blocking or delaying access when at least one CPU enters the secure mode. The means for controlling access to the one or more control resources or registers may include means for locking the one or more control resources or registers prior to the at least one CPU entering the secure mode. If the secure mode is a trusted execution environment, the means for controlling access to the one or more control resources or registers may include means for invoking a global secure-side lock on the one or more control resources or registers. Upon locking the one or more control resources or registers, a means for delay processing may be activated within the CPU entering the secure mode to delay execution of pertinent portions of secure code on the CPU. The means for delay processing may be set to duration so any malicious change made by non-secure code to the one or more control resources or registers prior to locking access to the one or more registers causes the CPU entering the secure mode to fail prior to execution of pertinent portions of secure code. Upon locking access to the one or more control resources or registers, a means for power loop processing may be activated within the CPU entering the secure mode. The means for power loop processing may be set to stress the CPU so that any malicious change made by non-secure code to the one or more control resources or registers to reduce a voltage to a threshold level prior to locking access to the one or more registers causes the CPU entering the secure mode to fail prior to execution of pertinent portions of secure code.

Still further, instructions may be provided for control access by non-secure code to one or more control resources that affect the physical operation of the CPU to prevent non-secure code from affecting the physical operation of a CPU entering the secure mode. For example, a non-transitory machine-readable storage medium may be provided for use with a computing system equipped with a plurality of central processing units (CPUs), the machine-readable storage medium having one or more instructions which when executed by at least one processing circuit of the computing system causes the at least one processing circuit to: detect a CPU of the computing system entering a secure mode; and control access by non-secure code to one or more control resources that affect the physical operation of the CPU to prevent the non-secure code from affecting the physical operation of the CPU that is entering the secure mode.

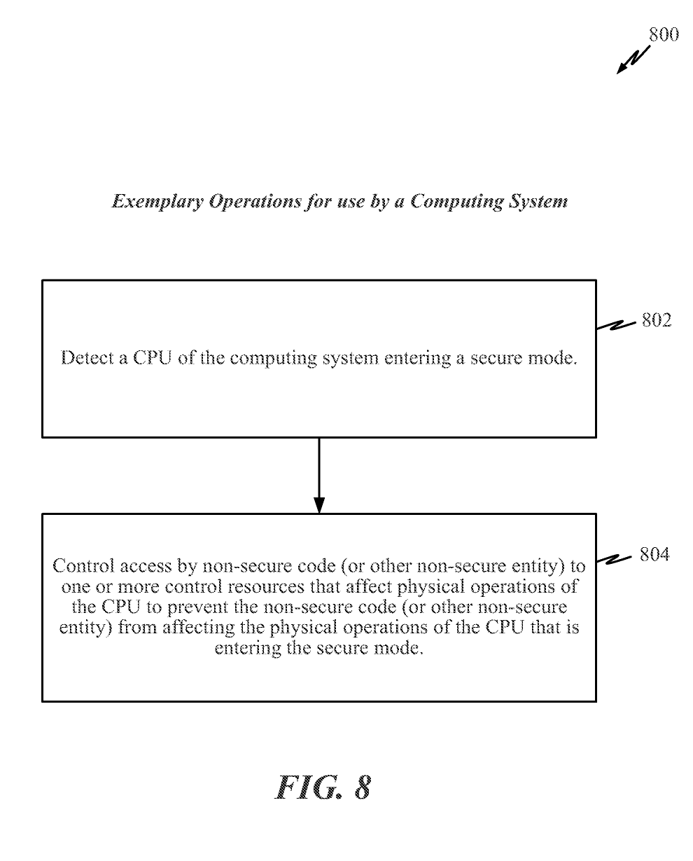

FIG. 8 broadly illustrates and summarizes methods or procedures 800 that may be performed by suitably equipped processing devices or components. In particular, FIG. 8 illustrates exemplary operations for use by a computing system that might be equipped with multiple CPUs. Briefly, at 802, a CPU of the computing system is detected entering a secure mode by, for example, a grey-list controller receiving a suitable signal. At 804, access by non-secure code (or other non-secure entity such as a DMA) to one or more control resources that affect the physical operation of the CPU is controlled by, for example, a grey-list controller to prevent the non-secure code (or other non-secure entity) from affecting the physical operation of the CPU that is entering the secure mode, using the techniques already described.

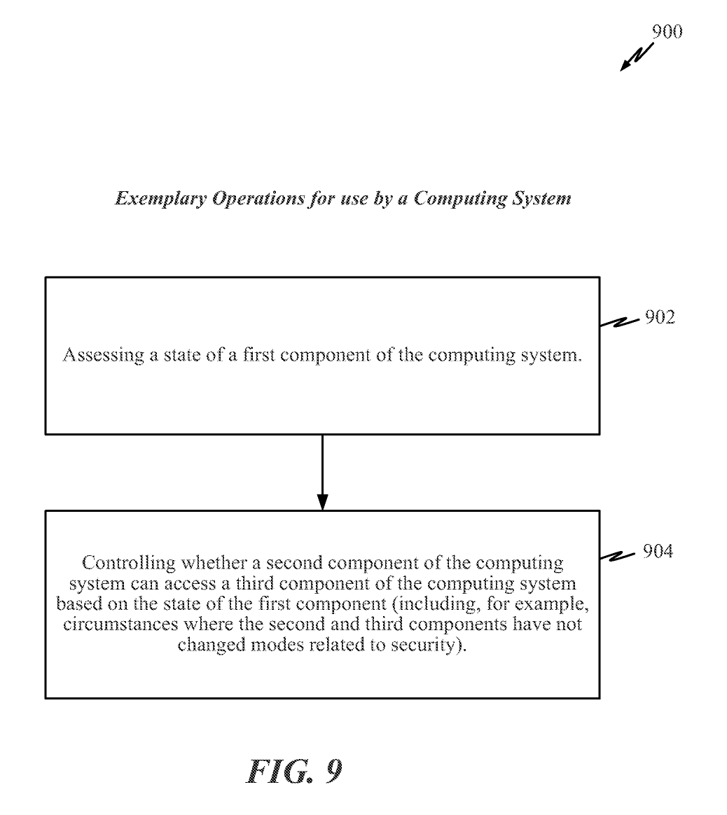

FIG. 9 broadly illustrates and summarizes more general methods or procedures 900 that may be performed by a computing system (that does not necessarily have multiple CPUs). Briefly, at 902, a state of a first component of the computing system is assessed, and, at 904, whether or not a second component of the computing system can access a third component of the computing system is controlled based on the state of the first component (i.e. the third party), including circumstances such as, for example, where the second and third components have not changed modes related to security (e.g. when they both remain in a non-secure mode).

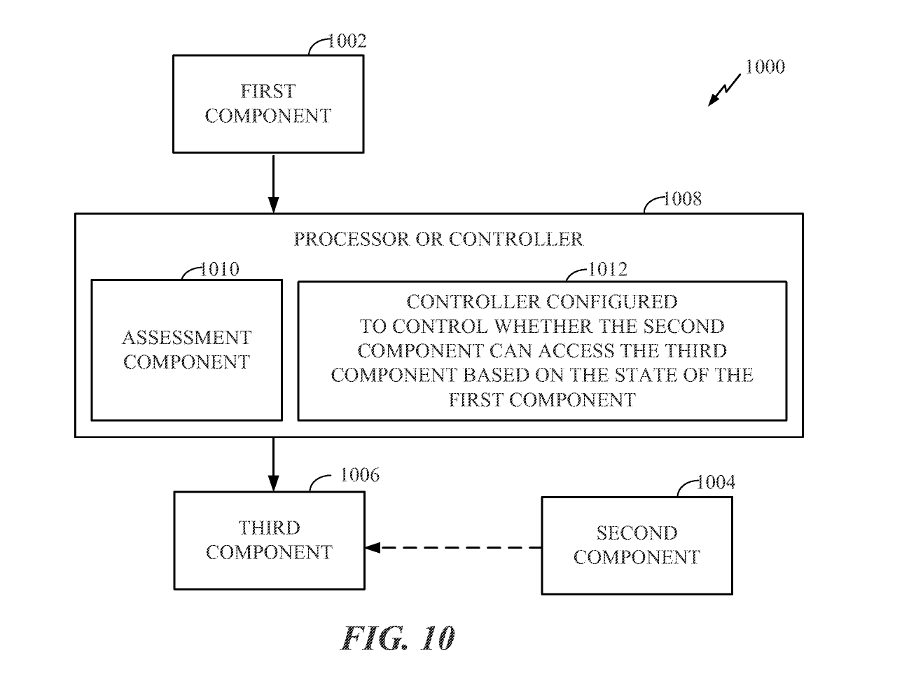

FIG. 10 broadly illustrates and summarizes a generalized computing system 1000 that does not necessarily have multiple CPUs. Computing system 1000 includes a first component 1002, a second component 1004, and a third component 1006. A processor or controller 1008 includes an assessment component 1010 configured to assess a state of the first component 1002 of the computing system (by, for example, receiving a signal therefrom), and a controller 1012 configured to control whether the second component 1004 can access the third component 1006 based on the state of the first component when, for example, the second and third components have not changed modes related to security. In FIG. 10, the connection between the second component 1004 and the third component 1006 is shown in phantom lines to emphasize that the second component may or may not be able to access the third component, depending upon the state of the first component.

In this general example, the first component is the aforementioned “third party” and the signal received by the processor or controller 1008 that is used to control whether the second component can access the third components is the “third party signal.” In some particular examples, described above, the first component 1002 is a first CPU entering into a secure mode to run secure code (or it is the secure code itself). The second component 1004 is non-secure code running on a second CPU. The third component 1006 may be the aforementioned grey-list registers or other control resources.

The various components of FIG. 10 may be replaced with a suitable means for performing or controlling corresponding operations. Hence, in at least some examples, means are provided for assessing a state of a first component of a computing system (such as assessment component 1010), and means a provided for controlling whether a second component of the computing system can access a third component of the computing system (such as the controller 1012) based on the state of the first component to, for example, mitigate malicious attacks that would exploit changes to the third component.

Still further, instructions may be provided for controlling access by the second component 1004 to the third component 1006. For example, a non-transitory machine-readable storage medium may be provided for use with the computing system 1000 wherein the machine-readable storage medium has one or more instructions which when executed by the processor or controller 1008 causes the processor or controller 1008 to: assess a state of the first component 1002 of the computing system; and control whether the second component 1004 of the computing system can access the third component 1006 of the computing system based on the state of the first component when, for example, the second and third components have not changed modes related to security.

In the following sections, examples are provided wherein grey-list components and procedures are employed within systems having storage controllers and/or video decoders to prevent malicious attacks on the storage controllers and/or video decoders.

### Storage Controller Examples

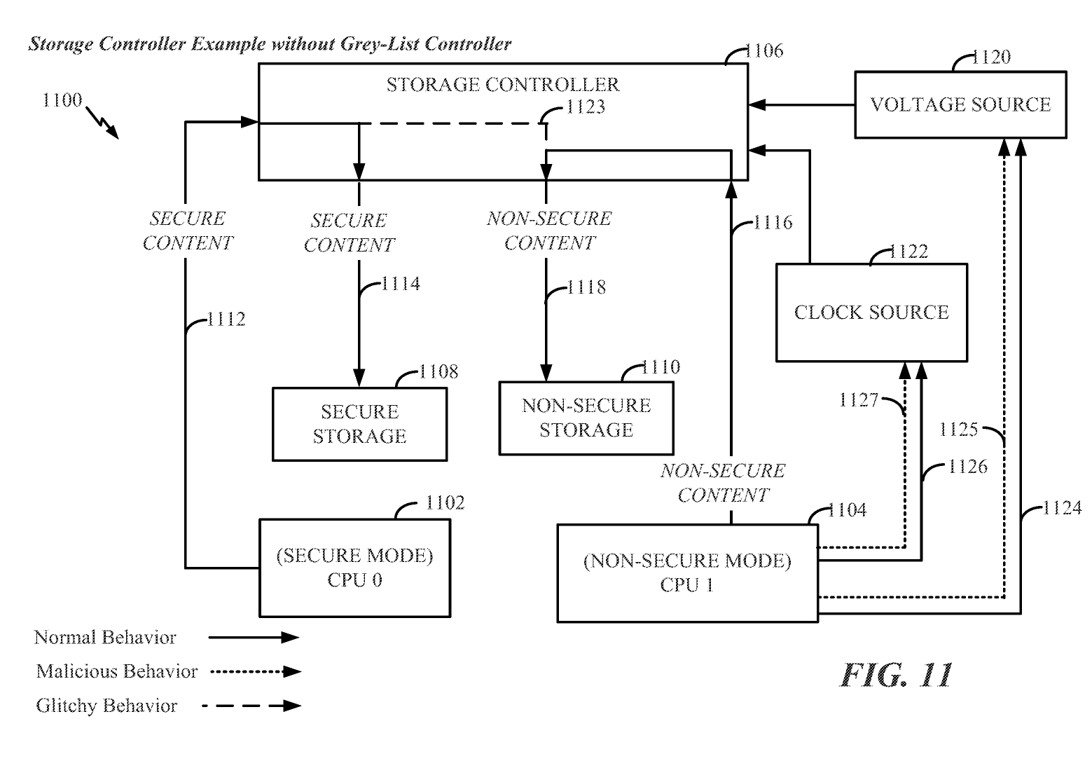

FIG. 11 illustrates a computing system 1100 having a first and second CPUs 1102 and 1104 and a DMA or other storage controller 1106 that controls access to both a secure storage component 1108 and a non-secure storage component 1110, where the computing system 1100 is vulnerable to malicious attacks to obtain secure content. In the example of FIG. 11, the first CPU (CPU 0) is a secure mode CPU, whereas the second CPU (CPU 1) is a non-secure mode CPU. The secure mode CPU 1102 provides secure content (e.g. cryptographic keys) to the storage controller 1106 (as illustrated by logic pathway 1112), with the secure content then forwarded by the storage controller 1106 to the secure storage component 1108 via pathway 1114. (Note that the line 1112 of FIG. 11 is meant to represent a logical step (or logic pathway), rather than a physical signal line. In practice, secure content is stored in a protected secure memory region and the storage controller is requested to read the secure content from protected secure memory region. And so, the secure CPU effectively “gives” or otherwise “provides” the secure content to the storage controller, as represented by logic pathway 1112.) The non-secure mode CPU 1104 provides non-secure content (such as normal unprotected data) to the storage controller 1106 as shown by logic pathway 1116 (which is then forwarded by the storage controller 1106 to the non-secure storage component 1110 along a line or pathway 1118. (As with logic pathway 1112, pathway 1116 is meant to represent a logical step, rather than a physical signal line, for the same reasons as already noted.)

During normal operation, the storage controller 1106 routes secure content only to the secure storage component 1108 and not to the non-secure storage component 1110 to prevent the secure content from being exposed to programs running on the non-secure CPU 1104. During operation, the storage controller 1106 also receives power from a voltage source 1120 and clock signals from a clock source 1122, which in turn may receive input from the non-secure mode CPU 1104 along lines 1124 and 1126, respectively. For example, non-secure code running on the non-secure CPU might adjust the clock and/or voltage applied to the storage controller 1106 to adjust or optimize performance (and thereby power consumption) based on throughput needs to save power. (Although not shown, the secure mode CPU 1102 may also send signals to the voltage source 1120 and the clock source 1122 but, for the purposes of this discussion of the computer system of FIG. 11, such signals are not important and so the corresponding signals lines are omitted in the drawing.) During normal operation, the clock and voltage applied to the storage controller 1106 are set by code to levels or values sufficient to allow the storage controller 1106 to function normally and reliably.

However, malicious code running on the non-secure CPU 1104 might attempt to change the clock and voltage settings of the storage controller 1106 in an effort to overclock or undervoltage the storage controller to cause a glitch in the operation of the storage controller 1106—as shown by internal dashed line 1123—that causes secure content to be erroneously sent by the storage controller 1106 to the non-secure storage component 1110. If secure content is erroneously stored in the non-secure storage component 1110, the malicious code running on the non-secure CPU 1104 may then access that data, thus exposing cryptographic keys to hackers or the like. (Note that dashed line 1123 is meant to illustrate glitchy behavior, i.e. behavior due to a glitch, and is not intended to represent an actual physical signal line.)

In FIG. 11, dotted-line signals 1125 and 1127 are shown to highlight the malicious behavior whereby improper signals may be sent by the non-secure CPU 1104 to the clock and voltage sources in an effort to change the clock and/or voltage to trigger the aforementioned glitchy behavior (represented by dashed line 1123). It should be noted that in a practical system the malicious signals would be sent along the same physical interconnection lines that interconnect the non-secure CPU to the clock and voltage sources used for normal (i.e. non-malicious signals). That is, normal behavior signals and malicious behavior signals would be carried along the same physical interconnection wires or lines. The normal and malicious behavior signals are shown separately in the figure to more clearly highlight the malicious behavior and, as will be shown in the next figure, to allow the solution to the problem to be clearly illustrated.

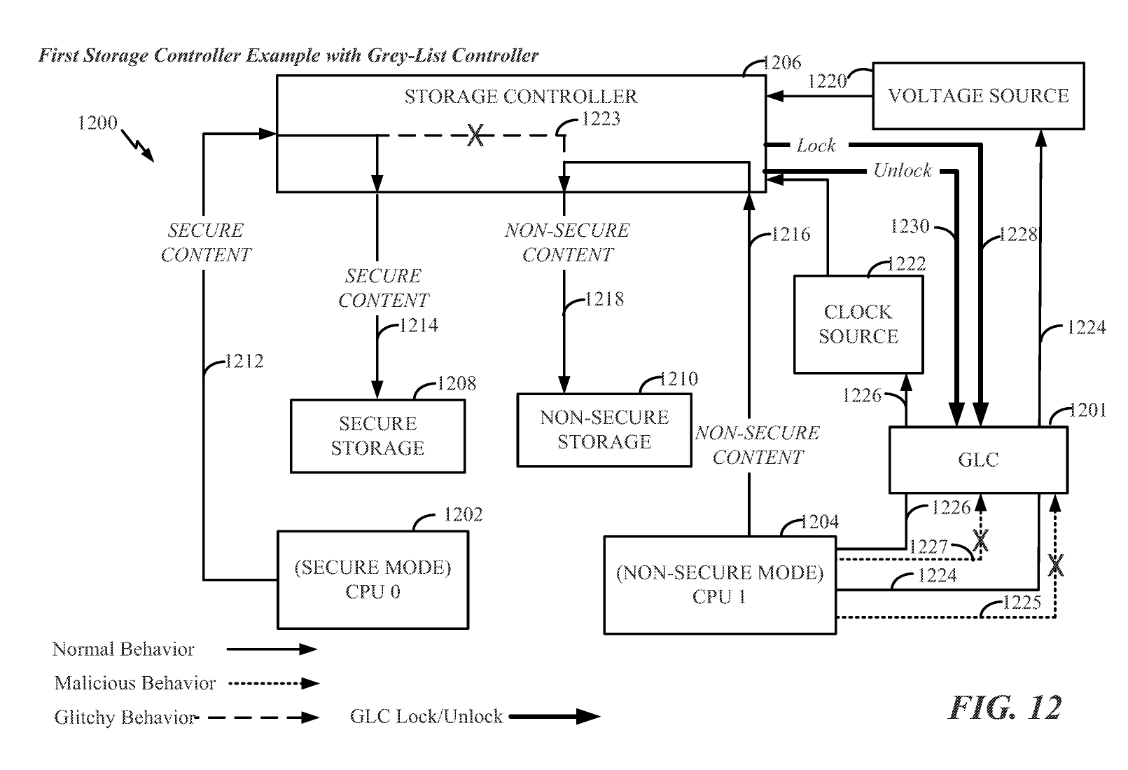

FIG. 12 illustrates a first alternative computing system 1200 equipped with a grey-list lock controller (GLC) 1201 to prevent the malicious behavior of FIG. 11. Many of the other components of FIG. 12 are the same as those in FIG. 11 and will not be described in detail. Briefly, computing system 1200 again has secure and non-secure CPUs 1202 and 1204 and a storage controller 1206 that controls access to secure and non-secure storage components 1208 and 1210. The secure mode CPU 1202 provides secure content to the storage controller 1206 (as shown by logic pathway 1212), which is then forwarded to the secure storage component 1208 along line 1214. (As with logic pathway 1112 of FIG. 11, pathway 1212 of FIG. 12 is meant to represent a logical step, rather than a physical signal line. As noted above, in practice, secure content is stored in a protected secure memory region and the storage controller is requested to read the secure content from protected secure memory region.) The non-secure mode CPU 1204 routes non-secure content to the storage controller 1206 (via a logic pathway 1216), which is then forwarded to the non-secure storage component 1210 along line 1218.

During normal operation, the storage controller 1206 again routes secure content to the secure storage component 1208 while operating using properly set power levels from a voltage source 1220 and properly set clock signals a clock source 1222, which in turn may receive input originating from the non-secure mode CPU 1204. However, with the system of FIG. 12, the grey-list lock controller 1201 is interposed between the non-secure CPU 1204 and the voltage and clock sources 1220 and 1222 along lines 1224 and 1226 so that clock and voltage registers can be locked prior to secure operations of the storage controller 1206 to prevent the malicious behavior of FIG. 11. By locking, it is meant the access to the registers is blocked or at least delayed by any amount of time sufficient to prevent malicious attacks of the type described above.

More specifically, in the example of FIG. 12, the grey-list lock controller 1201 receives a lock signal from the storage controller 1206 along a lock signal line or pathway 1228 that serves to lock grey-list clock and voltage registers prior to secure operations of the storage controller 1206 to prevent malicious code from causing the above-described glitchy behavior 1223 within the storage controller 1206 (that would result in secure content being forwarded to the non-secure storage component 1210). The grey-list lock controller 1201 later receives an unlock signal from the storage controller 1206 along an unlock signal line or pathway 1230 (or along the same line or pathway 1228 used for the lock signal) that serves to unlock the clock and voltage registers following secure operations to again allow non-secure code to control the clock and voltage during non-secure operations. So, for example, when secure content is first provided to the storage controller 1206 under the control of the secure CPU 1202, the storage controller 1206 issues the lock signal to the grey-list lock controller 1201 and then transfers the secure content to the secure storage component 1208 along line 1214. Once the transfer is complete, the storage controller 1206 issues the unlock signal to the grey-list lock controller 1201 to unlock the clock and voltage registers.

Note that, depending upon the implementation, the grey-list clock and voltage registers can be components of the voltage and clock source components 1220 and 1222, components of the GLC 1201, or maintained or stored elsewhere in the system. (See, for example, the grey-list control registers shown in FIG. 2 and discussed above). In FIG. 12, dotted-line signals 1225 and 1227 are again shown alongside signal pathways 1224 and 1226 to highlight the malicious behavior whereby improper signals may be output by the non-secure CPU 1204 in an attempt to glitch the storage controller 1206. The bold “X” across the signal lines in the figure illustrates that the malicious attack will be blocked or otherwise prevented by the GLC 1201. A similar bold “X” is shown across glitchy behavior 1223 to show that the glitch is prevented. The lock and unlock signal lines or pathways 1228 and 1230 are highlighted in bold.

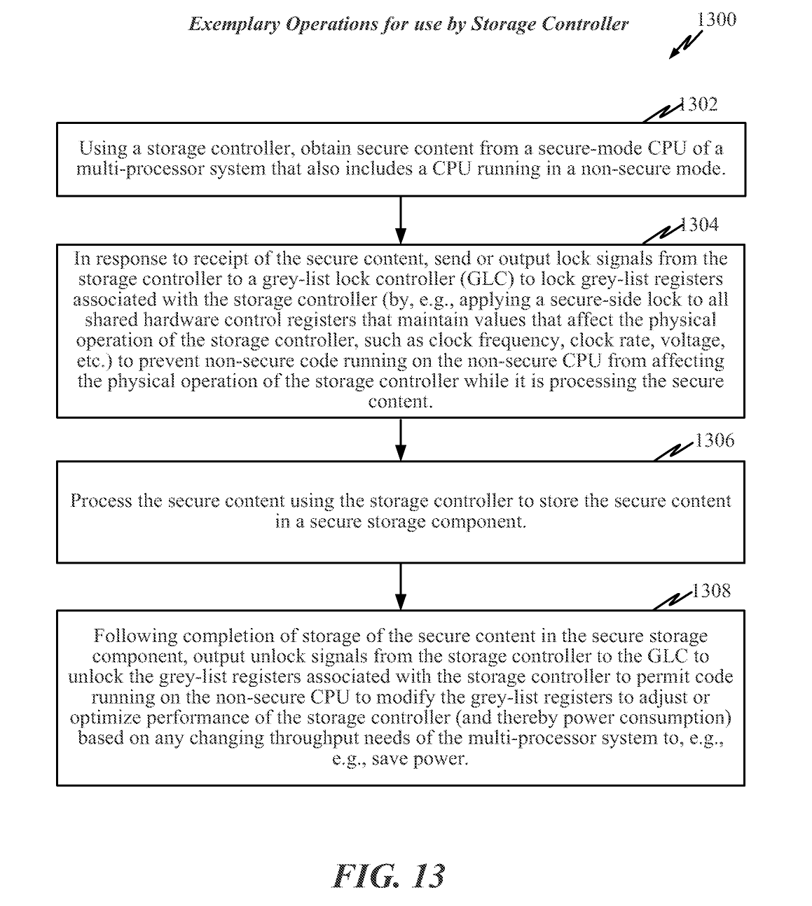

FIG. 13 illustrates and summarizes methods or procedures 1300 that may be performed by the storage controller of the processing system of FIG. 12. Briefly, at 1302, the storage controller obtains secure content from a secure-mode CPU of a multi-processor system that also includes a CPU running in a non-secure mode. The non-secure CPU may include code for adjusting clock and voltage control registers to adjust or optimize the performance of the storage controller (and thereby power consumption) based on any changing throughput needs of the multi-processor system to, e.g., e.g., save power. At 1304, in response to receipt of the secure content, the storage controller outputs one or more lock signals to a grey-list controller (GLC) to lock grey-list registers associated with the storage controller (by, e.g., applying a secure-side lock to all shared hardware control registers that maintain values that affect the physical operation of the storage controller, such as clock frequency, clock rate, voltage, etc., to block and/or delay access to those registers, where the delay may be by a random or pseudorandom amount of time) to prevent non-secure code running on the non-secure CPU from affecting the physical operation of the storage controller while it is processing the secure content. At 1306, the storage controller processes the secure content to store the secure content in a secure storage component. (By way of example, a NAND flash device might have a secure and non-secure partition. A CPU does not directly access a NAND flash, but a CPU can ask the storage controller to read/write to the NAND. Only a secure mode CPU can ask the storage controller to read from the secure partition of the NAND.) At 1308, following completion of storage of the secure content in the secure storage component, the storage controller sends or outputs one or more unlock signals to the GLC to unlock the grey-list registers associated with the storage controller to again permit code running on the non-secure CPU to modify the grey-list clock and voltage registers to adjust or optimize performance of the storage controller (and thereby power consumption) based on any changing throughput needs of the multi-processor system to, e.g., e.g., save power.

Although not shown in FIG. 13, additional functions or procedures may be implemented to further mitigate malicious attacks, such as the procedures described above wherein delay processing loops are employed (see, e.g., block 304 of FIG. 3) or wherein power processing loops are employed (see, e.g. block 306 of FIG. 3).

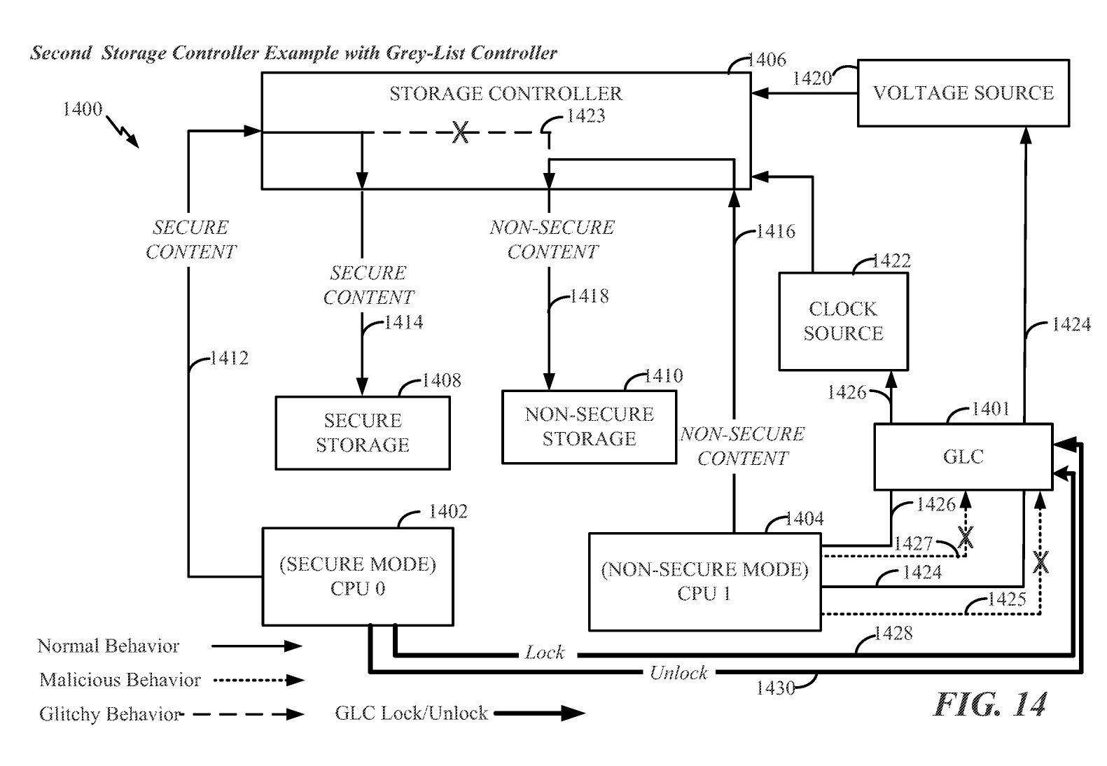

FIG. 14 illustrates a second alternative computing system 1400 equipped with a grey-list lock controller 1401 to prevent the malicious behavior illustrated in FIG. 11. Briefly, computing system 1400 again has secure and non-secure CPUs 1402 and 1404 and a storage controller 1406 that controls access to secure and non-secure storage components 1408 and 1410. The secure mode CPU 1402 provides secure content for the storage controller 1406 (via logic pathway 1412), which is then forwarded to the secure storage component 1408 along line 1414. (As with the logic pathways 1112 and 1212 discussed above, pathway 1412 of FIG. 14 is meant to represent a logical step, rather than a physical signal line.) The non-secure mode CPU 1404 routes non-secure content to the storage controller 1406 via a line 1416, which is then forwarded to the non-secure storage component 1410 along line 1418.

During normal operation, the storage controller 1406 routes secure content to the secure storage component 1408 while operating using properly set power levels and clock signals (from voltage and clock sources 1420 and 1422), which in turn may receive input originating from the non-secure mode CPU 1404. As with FIG. 12, the grey-list lock controller 1401 is interposed so that clock and voltage registers can be locked prior to secure operations of the storage controller 1406 to prevent the malicious behavior of FIG. 11. However, in the example of FIG. 14, the secure CPU 1402 sends the lock and unlock signals to the grey-list lock controller 1401 via control signals along lines 1428 and 1430. More specifically, the grey-list lock controller 1401 receives a lock signal from the secure CPU 1402 prior to the secure CPU 1402 sending secure content to the storage controller 1406. The grey-list lock controller 1401 later receives the unlock signal from the secure CPU 1402 following secure operations.

Once again, dotted-line signals 1425 and 1427 are shown to highlight malicious behavior whereby improper signals might be output by the non-secure CPU 1404 in an attempt to glitch the storage controller 1406. The bold “X” across the lines in the figure shows that the malicious attack is blocked or otherwise prevented by the grey-list lock controller 1401. The bold “X” shown across glitchy behavior pathway 1423 illustrates that the glitch is prevented. (As with dashed lines 1123 and 1223 of FIGS. 11 and 12, dashed line 1423 is intended to represent glitchy behavior and not an actual physical signal pathway.) The lock and unlock signal lines or pathways 1428 and 1430 are again highlighted in bold.

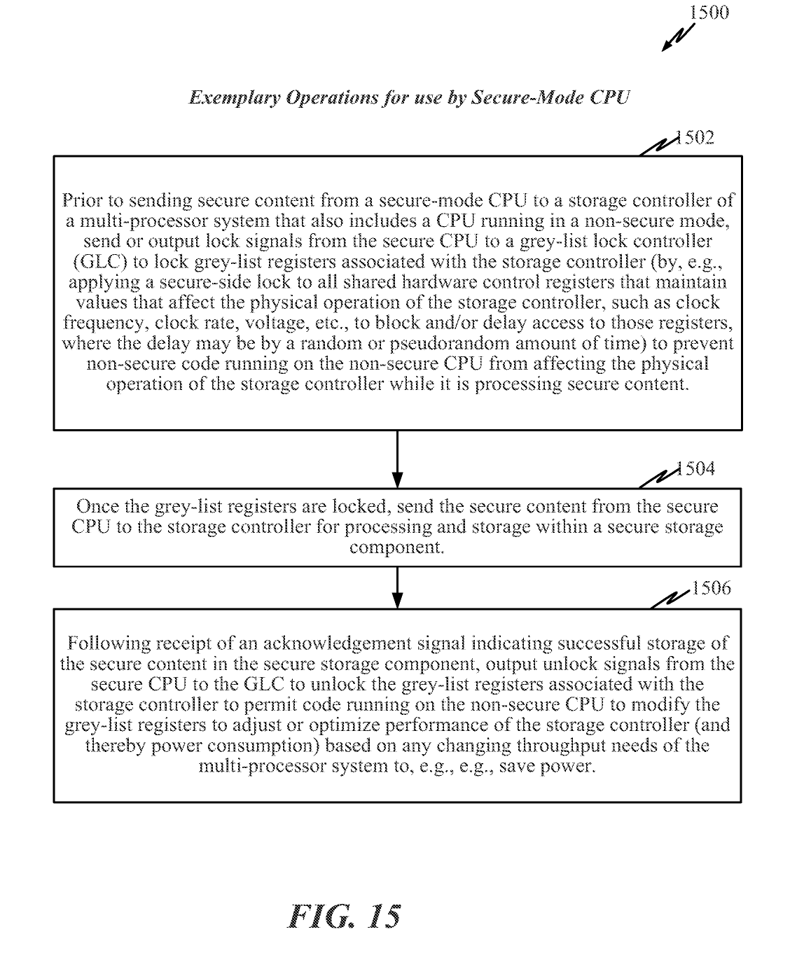

FIG. 15 illustrates and summarizes methods or procedures 1500 that may be performed by the secure CPU of the processing system of FIG. 14. Briefly, at 1502, prior to sending secure content from a secure-mode CPU to a storage controller of a multi-processor system that also includes a CPU running in a non-secure mode, the secure CPU outputs lock signals to a grey-list controller to lock grey-list registers associated with the storage controller (by, e.g., applying a secure-side lock to all shared hardware control registers that maintain values that affect the physical operation of the storage controller, such as clock frequency, clock rate, voltage, etc., to block and/or delay access to those registers, where the delay may be by a random or pseudorandom amount of time in the manner discussed above) to prevent non-secure code running on the non-secure CPU from affecting the physical operation of the storage controller while it is processing secure content. At 1502, once the grey-list registers are locked, the secure CPU sends the secure content to the storage controller for processing and storage within a secure storage component. At 1504, following receipt of an acknowledgement signal indicating successful storage of the secure content in the secure storage component, the secure CPU outputs or sends unlock signals to the GLC to unlock the grey-list registers associated with the storage controller to permit code running on the non-secure CPU to again modify the grey-list registers to adjust or optimize performance of the storage controller based on any changing throughput needs of the multi-processor system to, e.g., e.g., save power. Although not shown in FIG. 15, additional functions or procedures may be implemented to further mitigate malicious attacks, such as the delay processing loops and power processing loops discussed above.

### Video Decode Engine Examples

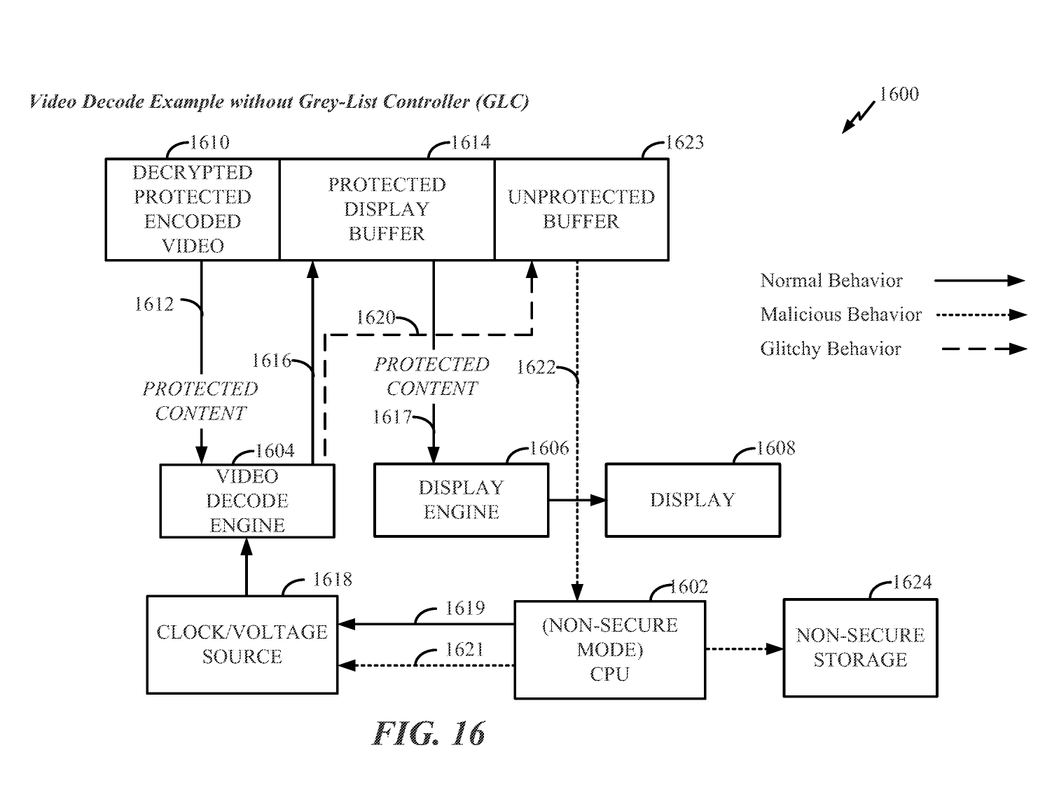

FIG. 16 illustrates a video processing system 1600 having a non-secure CPU 1602 and a video decode engine 1604, a display engine 1606 and a display 1608, where the system is vulnerable to malicious attacks to obtain protected content. Encoded and protected video content is received by the video decode engine 1604 from a decrypted protected video source 1610 along a signal line or pathway 1612, which may be a portion of RAM. (By way of example, encoded content might be encoded using H.264 video encoding. Protected means that access to this region of memory is restricted to some components, e.g. a video decode engine). The video decode engine 1604 decodes the protected video content and forwards the protected content to a protected display buffer 1614 (which might also be a portion of RAM) along a signal line or pathway 1616. The protected content is, in turn, routed along pathway 1617 to the display engine 1606 for display on video display 1608. The video decode engine 1604 operates based on clock signals and voltage levels supplied by a clock/voltage source 1618 (or from separate clock and voltage sources, as shown above). The non-secure CPU 1602 may control the clock/voltage source 1618 to, for example, adjust the clock and/or voltage applied to the video decode engine 1604 to set the performance (and thereby power consumption) of the video decode engine 1604 based, e.g., on video format (e.g.: 1080p, 4K, 30 fps, 60 fps, etc., as each may have different performance requirements). Control signals may be sent by the non-secure CPU 1602 to the clock/voltage source along a pathway 1619.

Ordinarily, assuming proper and routine operations, none of the protected video content is accessible by the non-secure CPU 1602. However, malicious code running on the non-secure CPU 1602 might change the clock and/or voltage supplied by the clock/voltage source 1618 (via malicious signals 1621) so as to glitch the video decode engine 1604, causing it to instead store decoded video content in an unprotected buffer 1623 (that may also be a portion of RAM), which can be accessed by the non-secure CPU 1602 along line or pathway 1622. The glitchy behavior is shown using dashed line 1620. Any protected content obtained by the malicious code of the non-secure CPU 1602 may be then output to a non-secure storage component 1624 for retrieval or access by hackers or the like. Signals 1621 and 1622 are shown in dotted lines to show that they represent malicious behavior.

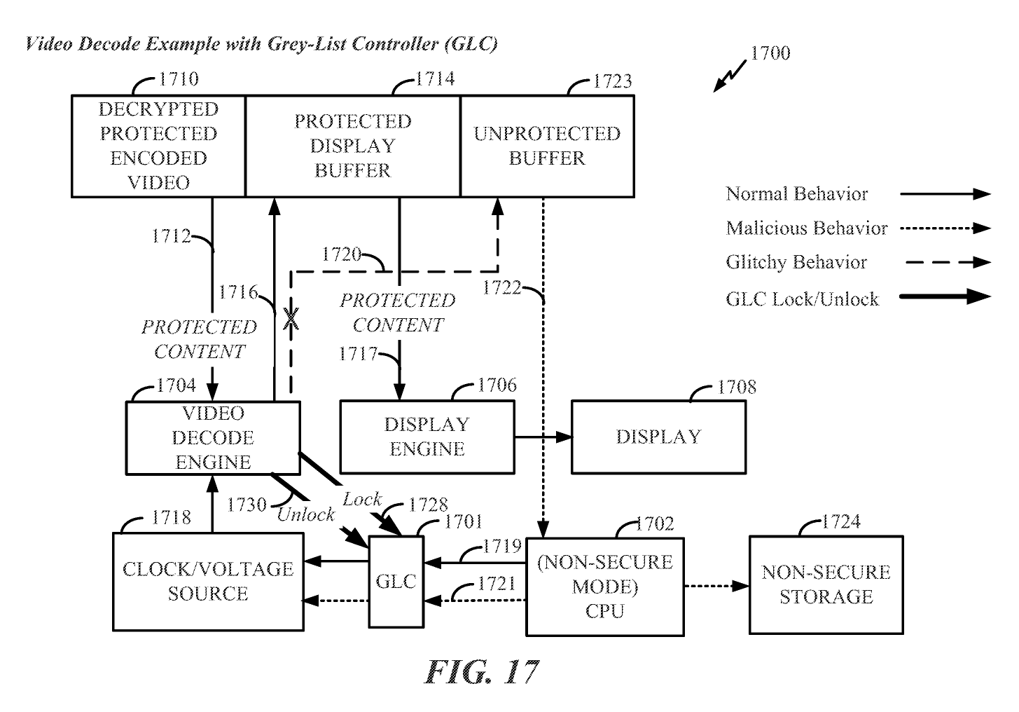

FIG. 17 illustrates an alternative video processing system 1700 equipped with a grey-list lock controller (GLC) 1701 to prevent the malicious behavior illustrated in FIG. 16. Many of the other components of FIG. 17 are the same as those in FIG. 16 and will not be described in detail. Briefly, the processing system once again has a non-secure CPU 1702 and a video decode engine 1704, a display engine 1706 and a video display 1708. Protected video (received by the video decode engine 1704 from a decrypted protected video source 1710 such as portion of RAM along a signal line or pathway 1712) is decoded by the video decode engine 1704 and forwarded to a protected display buffer 1714 (which may also be a portion of RAM) along a pathway 1716. The protected content is, in turn, fed along pathway 1717 to the display engine 1706 for display via display 1708. The video decode engine 1704 again operates based on clock/voltages supplied by a clock/voltage source 1718. Assuming proper operations, none of the protected video content is accessible by the non-secure CPU 1702 via unprotected buffer 1723. However, malicious code running on the non-secure CPU 1702 might here again seek to change the clock and/or voltage to glitch the video decode engine 1704.

However, with the system of FIG. 17, the grey-list lock controller 1701 is interposed between the non-secure CPU 1702 and the clock/voltage source 1718 along lines 1719 and 1721 so that clock and voltage registers can be locked prior to the decoding of protected content by video decode engine 1704 to prevent the malicious behavior of FIG. 16. By locking, it is again meant the access to the registers is blocked and at least delayed by any amount of time sufficient to prevent malicious attacks of the type described above. More specifically, in the example of FIG. 17, the grey-list lock controller 1701 receives a lock signal from the video decode engine 1704 along a lock signal line 1728 that serves to lock grey-list clock and voltage registers to prevent malicious code from causing the above-described glitchy behavior 1720 (that would result in protected content being forwarded to the non-secure CPU 1702 and ultimately to a non-secure storage 1724). The grey-list lock controller 1701 later receives an unlock signal from the video decode engine 1704 along an unlock signal line 1730 that serves to unlock clock and voltage registers following the display of protected content to again allow the non-secure CPU 1702 to control the clock and voltage.

Note that, depending upon the implementation, the grey-list clock and voltage registers can be components of the voltage/clock source component 1718, components of the GLC 1701, or maintained or stored elsewhere in the system. (See, for example, the grey-list control registers shown in FIG. 2 and discussed above). In FIG. 17, the bold “X” across glitch pathway 1720 illustrates that the malicious attack will be blocked by the grey-list lock controller 1701. The lock and unlock signal pathways 1728 and 1730 are highlighted in bold.

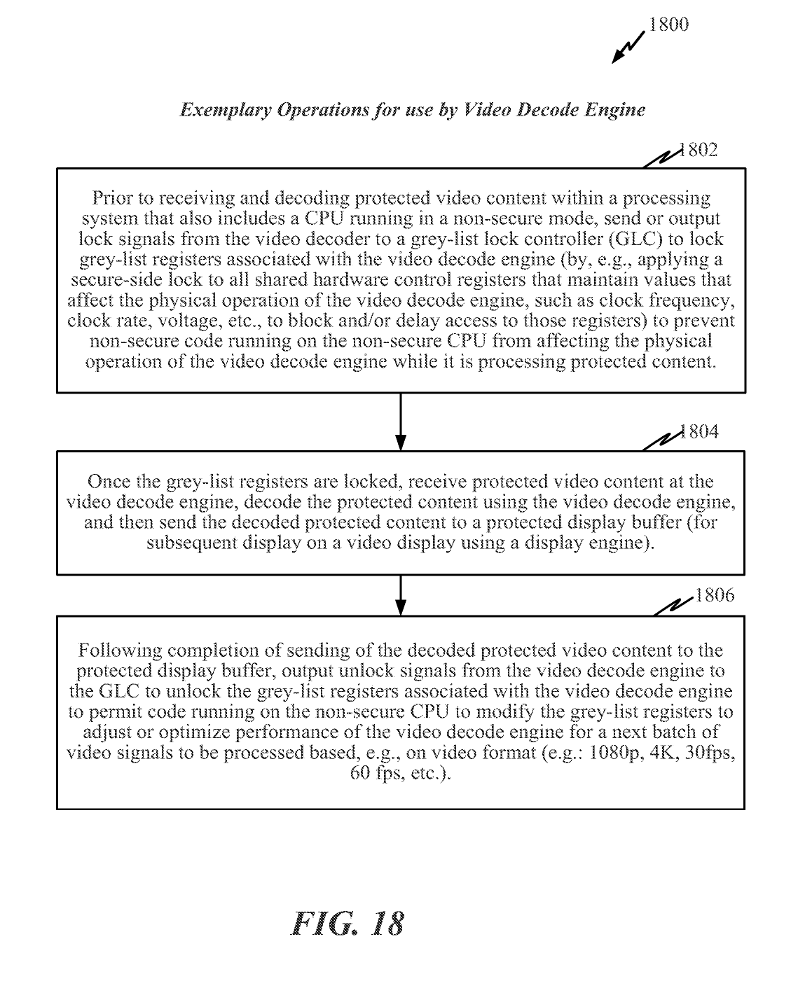

FIG. 18 illustrates and summarizes methods or procedures 1800 that may be performed by the video decode engine of the processing system of FIG. 17. Briefly, at 1802, prior to receiving and decoding protected video content within a processing system that also includes a CPU running in a non-secure mode, the video decode engine sends or outputs lock signals to a grey-list lock controller to lock grey-list registers associated with the video decode engine (by, e.g., applying a secure-side lock to all shared hardware control registers that maintain values that affect the physical operation of the video decode engine, such as clock frequency, clock rate, voltage, etc., to block and/or delay access to those registers, where the delay may be by a random or pseudorandom amount of time) to prevent non-secure code running on the non-secure CPU from affecting the physical operation of the video decode engine while it is processing protected content. At 1804, once the grey-list registers are locked, the video decode engine receives protected video content, decodes the protected content, and then sends the decoded protected content to a protected display buffer (for subsequent display on a video display using a display engine). At 1806, following completion of the sending of the decoded protected video content to the protected display buffer, the video decode engine sends or outputs unlock signals to the GLC to unlock the grey-list registers associated with the video decoder to permit code running on the non-secure CPU to modify the grey-list registers to adjust or optimize performance of the video decode engine for a next batch of video signals to be processed based, e.g., on video format (e.g.: 1080p, 4K, 30 fps, 60 fps, etc.).

Although not shown in FIG. 18, additional functions or procedures may be implemented to further mitigate malicious attacks, such as the procedures described above wherein delay processing loops are employed (see, e.g., block 304 of FIG. 3) or wherein power processing loops are employed (see, e.g. block 306 of FIG. 3).

Note that, herein, the terms “obtain” or “obtaining” broadly cover, e.g., calculating, computing, generating, acquiring, receiving, retrieving, inputting or performing any other suitable corresponding actions. Note also that aspects of the present disclosure may be described herein as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function.

Those of skill in the art would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system.

The methods or algorithms described in connection with the examples disclosed herein may be embodied directly in hardware, in a software module executable by a processor, or in a combination of both, in the form of processing unit, programming instructions, or other directions, and may be contained in a single device or distributed across multiple devices. A software module may reside in RAM memory, flash memory, ROM memory, EPROM memory, EEPROM memory, registers, hard disk, a removable disk, a CD-ROM, or any other form of storage medium known in the art. A storage medium may be coupled to the processor such that the processor can read information from, and write information to, the storage medium. In the alternative, the storage medium may be integral to the processor.

The various features of the invention described herein can be implemented in different systems without departing from the invention. It should be noted that the foregoing embodiments are merely examples and are not to be construed as limiting the invention. The description of the embodiments is intended to be illustrative, and not to limit the scope of the claims. As such, the present teachings can be readily applied to other types of apparatuses and many alternatives, modifications, and variations will be apparent to those skilled in the art.

Moreover, in the following description and claims the terms “coupled” and “connected,” along with their derivatives, may be used. It should be understood that these terms are not intended as synonyms for each other. Rather, in particular aspects, “connected” may be used to indicate that two or more elements are in direct physical or electrical contact with each other. “Coupled” may mean that two or more elements are in direct physical or electrical contact. However, “coupled” may also mean that two or more elements are not in direct contact with each other, but yet still co-operate or interact with each other.

An aspect is an implementation or example. Reference in the specification to “an aspect,” “one aspect,” “some aspects,” “various aspects,” or “other aspects” means that a particular feature, structure, or characteristic described in connection with the aspects is included in at least some aspects, but not necessarily all aspects, of the present techniques. The various appearances of “an aspect,” “one aspect,” or “some aspects” are not necessarily all referring to the same aspects. Elements or aspects from an aspect can be combined with elements or aspects of another aspect.

Not all components, features, structures, characteristics, etc. described and illustrated herein need be included in a particular aspect or aspects. If the specification states a component, feature, structure, or characteristic “may,” “might,” “can” or “could” be included, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

In each figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be noted that, although some aspects have been described in reference to particular implementations, other implementations are possible according to some aspects. Additionally, the arrangement and/or order of circuit elements or other features illustrated in the drawings and/or described herein need not be arranged as illustrated and described. Many other arrangements are possible according to some aspects.

What is claimed is:

1. A method for use by a computing system, comprising:
assessing a state of a first component of the computing system; and
controlling whether a second component of the computing system can access a third component of the computing system based on the state of the first component.

2. The method of claim 1, wherein the first component is a secure entity, the second component is a non-secure entity, and the third component is a control resource, and wherein controlling whether the second component can access the third component includes controlling whether the non-secure entity can access the control resource.

3. The method of claim 1, wherein assessing the state of the first component of the computing system includes obtaining a signal from the first component representative of a security mode of the first component.

4. The method of claim 1, wherein the first component switches from a non-secure mode to a secure mode while the second component and the third component remain in a non-secure mode.

5. The method of claim 1, wherein the first component is a central processing unit (CPU) entering a secure mode, the second component is a non-secure entity, and the third component includes one or more control resources that affect physical operations of the CPU entering the secure mode.

6. The method of claim 5,
wherein assessing a state of the first component includes detecting the CPU entering the secure mode; and
wherein controlling whether the second component can access the third component includes controlling access by the non-secure entity to the one or more control resources to prevent the non-secure entity from affecting the physical operations of the CPU entering the secure mode.

7. The method of claim 6, wherein detecting the CPU entering the secure mode comprises detecting any CPU of the computing system activating any secure code.

8. The method of claim 5, wherein the one or more control resources comprise one or more control registers, and wherein controlling whether the second component can access the third component includes controlling access by the non-secure entity to the one or more control registers.

9. The method of claim 8, wherein the one or more control registers include at least one register affecting one or more of clock frequency, clock timing, and device voltage.

10. The method of claim 8, wherein access by the non-secure entity to the one or more control registers is blocked or delayed when at least one CPU of the computing system enters the secure mode.

11. The method of claim 10, wherein the one or more control registers are locked (a) prior to the at least one CPU entering the secure mode or (b) after the at least one CPU enters the secure mode but before the at least one CPU executes sensitive code.

12. The method of claim 11, wherein the secure mode is a trusted execution environment and wherein access to the one or more control registers is locked by invoking a global secure-side lock on the one or more control registers.

13. The method of claim 10, wherein, upon locking the one or more control registers, a delay loop is activated within the at least one CPU entering the secure mode to delay execution of at least some secure code on the CPU.

14. The method of claim 13, wherein the delay loop is set to a duration so any change made by the non-secure entity to the one or more control registers prior to locking access to the one or more registers causes the at least one CPU entering the secure mode to fail prior to execution of at least some secure code.

15. The method of claim 10, wherein, upon locking access to the one or more control registers, a power loop is activated within the at least one CPU entering the secure mode.

16. The method of claim 15, wherein the power loop is set to stress the at least one CPU so that any change made by the non-secure entity to the one or more control registers to reduce a voltage to a threshold level prior to locking access to the one or more registers causes the at least one CPU entering the secure mode to fail prior to execution of at least some secure code.

17. The method of claim 8, wherein access by the non-secure entity to the one or more control registers is delayed by a random or pseudorandom amount of time.

18. A device for use with a computing system, comprising:
first, second and third components of the computing system; and
a processor configured to
assess a state of the first component of the computing system, and
control whether the second component can access the third component based on the state of the first component.

19. The device of claim 18, wherein the first component is secure code, the second component is a non-secure entity, and the third component is a control register.

20. The device of claim 18, wherein the processor is further configured to assess the state of the first component by obtaining a signal from the first component representative of a security mode of the first component.

21. An apparatus for use with a computing system, comprising:
means for assessing a state of a first component of the computing system; and
means for controlling whether a second component of the computing system can access a third component of the computing system based on the state of the first component.
